(19) United States
(12) Patent Application Publication
(10) Pub. No.: US 2019/0163758 A1
(43) Pub. Date: May 30, 2019

(54) METHOD AND SERVER FOR PRESENTING A RECOMMENDED CONTENT ITEM TO A USER

(71) Applicant: YANDEX EUROPE AG, Luzern (CH)

(72) Inventors: Dmitry Sergeevich ZHIVOTVOREV, Voronezhskaya obl (RU); Victor Grigorievich LAMBURT, Moscow (RU); Vladimir Vladimirovich NIKOLAEV, Uritsky r-n (RU); Dmitry Valerievich USHANOV, Moscow (RU); Yevgeny Andreevich SOKOLOV, Belokalitvinsky ds-t (RU)

(21) Appl. No.: 16/010,152

(22) Filed: Jun. 15, 2018

(30) Foreign Application Priority Data
Nov. 24, 2017 (RU) 2017140972

(51) Int. Cl. G06F 17/30; G06N 99/00

(52) U.S. Cl. CPC G06F 17/3053; G06F 17/30867; G06N 99/005; G06F 17/30554; G06F 17/30598

(57) ABSTRACT

A method and server for presenting an item with potentially undesirable content to a user are disclosed. The method comprises: receiving a presentation request and user interactions; and generating a first list of items. Items are associated with respective features and web resources. Items are ranked in first list based on user-specific scores indicative of their estimated relevance to user. A given item is associated with a given rank in first list. The method also comprises: generating for items demoting scores indicative of a degree of undesirability of content originating from respective resources; generating for items adjusted scores based on user-specific and demoting scores; generating a second list where items are ranked according to adjusted scores, where the given item is associated with an adjusted rank in the second list; and triggering presentation of items from second list to user. The given item is presented at the adjusted rank.

### CROSS-REFERENCE

The present application claims priority to Russian Patent Application No. 2017140972, entitled “Method and Server for Presented a Recommended Content Item to a User”, filed Nov. 24, 2017, the entirety of which is incorporated herein by reference.

### FIELD

The present technology relates to recommendation systems in general and, specifically, to a method and apparatus for presenting a recommended content item to a user.

### BACKGROUND

Various global or local communication networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of client devices (desktop, laptop, notebook, smartphone, tablets and the like) to have access to rich content (like images, audio, video, animation, and other multimedia content from such networks).

The volume of available information through various Internet resources has grown exponentially in the past couple of years. Several solutions have been developed in order to allow a typical user to find the information that the user is looking for. One example of such a solution is a search engine. Examples of the search engines include GOOGLE™ search engine, YANDEX™ search engine, YAHOO!™ search engine and the like. The user can access the search engine interface and submit a search query associated with the information that the user is desirous of locating on the Internet. In response to the search query, the search engine provides a ranked list of search results. The ranked list of search results is generated based on various ranking algorithms employed by the particular search engine that is being used by the user performing the search. The overall goal of such ranking algorithms is to present the most relevant search results at the top of the ranked list, while less relevant search results would be positioned on less prominent positions of the ranked list of search results (with the least relevant search results being located towards the bottom of the tanked list of search results).

The search engines typically provide a good search tool for a search query that the user knows apriori that she/he wants to search. In other words, if the user is interested in obtaining information about the most popular destinations in Italy (i.e. a known search topic), the user could submit a search query: “The most popular destinations in Italy?” The search engine will then present a ranked list of Internet resources that are potentially relevant to the search query. The user can then browse the ranked list of search results in order to obtain information she/he is interested in as it related to places to visit in Italy. If the user, for whatever reason, is not satisfied with the uncovered search results, the user can re-run the search, for example, with a more focused search query, such as “The most popular destinations in Italy in the summer?”, “The most popular destinations in the South of Italy?”, “The most popular destinations for a romantic getaway in Italy?”.

There is another approach that has been proposed for allowing the user to discover content and, more precisely, to allow for discovering and/or recommending content that the user may not be expressly interested in searching for. In a sense, such systems recommend content to the user without an express search request based on explicit or implicit interests of the user.

An example of such a system is a FLIPBOARD recommending system, which system aggregates and recommends content from various social networks. The FLIPBOARD recommending system presents the uncovered content in a “magazine style” format, where the user can “flip” through the pages with the recommended/aggregated content. The recommending system collects content from social media and other websites, presents it in magazine format, and allows users to “flip” through their social-networking feeds and feeds from websites that have partnered with the company, effectively “recommending” content to the user even though the user may not have expressly expressed her/his desire in the particular content.

Typically, recommendation systems provide personalized content to users based on previous user interactions with the recommendation service that can be indicative of user preferences for some particular content rather than other content. For example, if some particular content is associated with a large amount of previous user interactions, this particular content is more likely to be provided as personalized content since a large amount of previous user interactions may be indicative of relevant content. However, this might not be always the case such as with “click-bate” content where web content providers, in an attempt to draw user's clicks on their content, give the content provocative or scandalous titles in order to capture user attention and, therefore, entice users to interact with this content. This enticement may result in a large amount of previous user interactions being associated with the content without it being particularly relevant.

### SUMMARY

Developers of the present technology have appreciated certain technical drawbacks associated with the existing recommendation systems. Conventional recommendation systems usually use previous user interactions with items as basis for determining relevance of these items to users of a recommendation service. These conventional recommendation systems are based on an assumption that users often viewing and/or often interacting with certain items is indicative of their high relevance to the users. However, in some cases, this assumption may be flawed due to the fact that, for example, some web providers provide “click-bate” content which entices users to interact with it without the content being of particular relevance to the users. As such, this type of undesirable content may be determined as highly relevant by conventional recommendation systems due to the amount of user interactions associated therewith even though this might not be actually the case. As such, users of these conventional recommendation systems may be recommended with highly ranked undesirable content which is not beneficial for user satisfaction and user retention of a recommendation service.

It is an object of the present technology to ameliorate at least some of the inconveniences present in the prior art.

In accordance with a first broad aspect of the present technology, there is provided a method of presenting a recommended content item to a user on an electronic device. The recommended content item is associated with potentially undesirable content. The method is executable on a server hosting a recommendation service. The method comprises receiving, by the server, a request for presenting recommended content to the user. The method comprises receiving, by the server, an indication of previous user interactions of the user with the recommendation service. The method comprises generating, by a user-specific-ranking MLA implemented by the server, a ranked list of recommendable content items. Each content item in the ranked list of recommendable content items is associated with respective item features and a respective web resource. The item features of each content item are based on content of the respective content item. The content of each content item originates from the respective web resource. The user-specific-ranking MLA has been trained to generate user-specific ranking scores for content items based on respective item features and the indication of previous user interactions of the user with the recommendation service. Each content item in the ranked list of recommendable content items is associated with a respective user-specific ranking score that is indicative of an estimated relevance of the respective content item to the user. A given content item in the ranked list of recommendable content items is associated with a given rank in the ranked list of recommendable content items. The method comprises generating, by a user-independent-classifying MLA implemented by the server, a demoting score for each content item in the ranked list of recommendable content items. The user-independent-classifying MLA has been trained to classify content originating from the respective web resource into one of a plurality of content classes and to generate demoting scores for content items based on the respective one of the plurality of content classes of content that originates from the respective web resources. Each demoting score is indicative of a degree of undesirability of the content that originates from the respective web resource. The method comprises generating, by the server, an adjusted ranking score for each content item in the ranked list of recommendable content items based on the respective user-specific ranking score and the respective demoting score. The adjusted ranking score of the given content item is inferior to the user-specific ranking score of the given item. The method comprises generating, by the server, a modified ranked list of recommendable content items to be presented to the user based on the content items and the respectively associated adjusted ranking scores. The content items in the modified ranked list of recommendable content items are ranked according to the respective adjusted ranking scores. The given content item is associated with an adjusted rank in the modified ranked list of recommendable content items. The adjusted rank is inferior to the given rank. The method comprises triggering, by the server, a presentation of a ranked recommended list of content items to the user on the electronic device as the ranked recommended content. The ranked recommended list of content items comprises at least some content items from the modified ranked list of recommendable content items. The given content item is presented to the user at the adjusted rank in the modified ranked list of recommendable content items.

In some embodiments of the method, the plurality of content classes may comprise at least one undesirable-content class and at least one neutral-content class.

In some embodiments of the method, the at least one undesirable-content class may comprise a set of undesirable-content classes where each one of the set of undesirable-content classes may be associated with a respective type of undesirable content included in pre-determined content policies.

In some embodiments of the method, the content originating from the respective web resources may be an aggregate of the content of all content items hosted by the respective web resource.

In some embodiments of the method, the content originating from the respective web resources may be the content of the respective content item.

In some embodiments of the method, the content originating from the respective web resources may be: an aggregate of content of all content items hosted by the respective web resource weighted with a first weight; and content of the respective content item weighted with a second weight.

In some embodiments of the method, each web resource may comprise web pages hosted by a common domain.

In some embodiments of the method, each web resource may comprise a respective web page.

In some embodiments of the method, the method may further comprise limiting, by the server, the modified ranked list of recommendable items to a pre-determined number of top ranked recommendable content items according to the respective adjusted ranking scores.

In some embodiments of the method, the user-independent-classifying MLA may have been trained to classify content originating from the respective web resource into one of a plurality of content classes and to generate demoting scores for content items based on the respective one of the plurality of content classes of content originating from the respective web resources and a pre-determined content policy.

In some embodiments of the method, the pre-determined content policy may have been pre-determined by an operator of the user-independent-classifying MLA.

In some embodiments of the method, the pre-determined content policy may be indicative of a type of undesirable content.

In some embodiments of the method, the content originating from a given web resource is classified, by the user-independent-classifying MLA, on a periodic basis.

In some embodiments of the method, the content originating from a given web resource is classified, by the user-independent-classifying MLA, into (i) a first one of the plurality of content classes at a first moment in time and (ii) a second one of the plurality of content classes at a second moment in time.

In some embodiments of the method, at least one of the first moment in time and the second moment in time is prior to the receiving, by the server, the request for presenting the recommended content to the user.

In accordance with another broad aspect of the present technology, there is provided a server for presenting a recommended content item to a user on an electronic device. The recommended content item is associated with potentially undesirable content. The server hosts a recommendation service. The server is configured to receive a request for presenting recommended content to the user. The server is configured to receive an indication of previous user interactions of the user with the recommendation service. The server is configured to generate, by a user-specific-ranking MLA implemented by the server, a ranked list of recommendable content items. Each content item in the ranked list of recommendable content items is associated with respective item features and a respective web resource. The item features of each content item are based on content of the respective content item. The content of each content item originates from the respective web resource. The user-specific-ranking MLA has been trained to generate user-specific ranking scores for content items based on respective item features and the indication of previous user interactions of the user with the recommendation service. Each content item in the ranked list of recommendable content items is associated with a respective user-specific ranking score that is indicative of an estimated relevance of the respective content item to the user. A given content item in the ranked list of recommendable content items is associated with a given rank in the ranked list of recommendable content items. The server is configured to generate, by a user-independent-classifying MLA implemented by the server, a demoting score for each content item in the ranked list of recommendable content items. The user-independent-classifying MLA has been trained to classify content originating from the respective web resource into one of a plurality of content classes and to generate demoting scores for content items based on the respective one of the plurality of content classes of content originating from the respective web resources. Each demoting score is indicative of a degree of undesirability of the content originating from the respective web resource. The server is configured to generate an adjusted ranking score for each content item in the ranked list of recommendable content items based on the respective user-specific ranking score and the respective demoting score. The adjusted ranking score of the given content item is inferior to the user-specific ranking score of the given item. The server is configured to generate a modified ranked list of recommendable content items to be presented to the user based on the content items and the respectively associated adjusted ranking scores. The content items in the modified ranked list of recommendable content items are ranked according to the respective adjusted ranking scores. The given content item is associated with an adjusted rank in the modified ranked list of recommendable content items. The adjusted rank is inferior to the given rank. The server is configured to trigger a presentation of a ranked recommended list of content items to the user on the electronic device as the ranked recommended content. the ranked recommended list of content items comprises at least some content items from the modified ranked list of recommendable content items. The given content item is presented to the user at the adjusted rank in the modified ranked list of recommendable content items.

In some embodiments of the server, the plurality of content classes may comprise at least one undesirable-content class and at least one neutral-content class.

In some embodiments of the server, the at least one undesirable-content class may comprise a set of undesirable-content classes where each one of the set of undesirable-content classes may be associated with a respective type of undesirable content included in pre-determined content policies

In some embodiments of the server, the content originating from the respective web resources may be an aggregate of the content of all content items hosted by the respective web resource.

In some embodiments of the server, the content originating from the respective web resources may be the content of the respective content item.

In some embodiments of the server, the content originating from the respective web resources may be: an aggregate of content of all content items hosted by the respective web resource weighted with a first weight; and content of the respective content item weighted with a second weight.

In some embodiments of the server, each web resource may comprise web pages hosted by a common domain.

In some embodiments of the server, each web resource may comprise a respective web page.

In some embodiments of the server, the server may be further configured to limit the modified ranked list of recommendable items to a pre-determined number of top ranked recommendable content items according to the respective adjusted ranking scores.

In some embodiments of the server, the user-independent-classifying MLA may have been trained to classify content originating from the respective web resource into one of a plurality of content classes and to generate demoting scores for content items based on the respective one of the plurality of content classes of content originating from the respective web resources and a pre-determined content policy.

In some embodiments of the server, the pre-determined content policy may have been pre-determined by an operator of the user-independent-classifying MLA.

In some embodiments of the server, the pre-determined content policy may be indicative of a type of undesirable content.

In some embodiments of the server, the content originating from a given web resource is classified, by the user-independent-classifying MLA, on a periodic basis.

In some embodiments of the server, the content originating from a given web resource is classified, by the user-independent-classifying MLA, into (i) a first one of the plurality of content classes at a first moment in time and (ii) a second one of the plurality of content classes at a second moment in time.

In some embodiments of the server, at least one of the first moment in time and the second moment in time is prior to the receiving, by the server, the request for presenting the recommended content to the user.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a system suitable for implementing non-limiting embodiments of the present technology;

FIG. 2 schematically depicts content originating from a plurality of web resources of the system of FIG. 1 and respective content items in accordance with non-limiting embodiments of the present technology;

FIG. 3 schematically depicts a machine learning algorithm (MLA) implemented by the system of FIG. 1 and user-specific ranking scores generated for the content items in accordance with non-limiting embodiments of the present technology;

FIG. 4 schematically depicts a ranked list of recommendable content items in accordance with non-limiting embodiments of the present technology;

FIG. 5 schematically depicts another machine learning algorithm (MLA) implemented by the system of FIG. 1 and demoting scores generated for the content items in accordance with non-limiting embodiments of the present technology;

FIG. 6 schematically depicts a process for generation of adjusted ranking scores for the content items based on user-specific ranking scores and demoting scores in accordance with non-limiting embodiments of the present technology;

FIG. 7 schematically depicts a modified ranked list of recommendable content items in accordance with non-limiting embodiments of the present technology; and

FIG. 8 depicts a block diagram of a method, the method being executable within the system of FIG. 1 and being implemented in accordance with non-limiting embodiments of the present technology.

### DETAILED DESCRIPTION

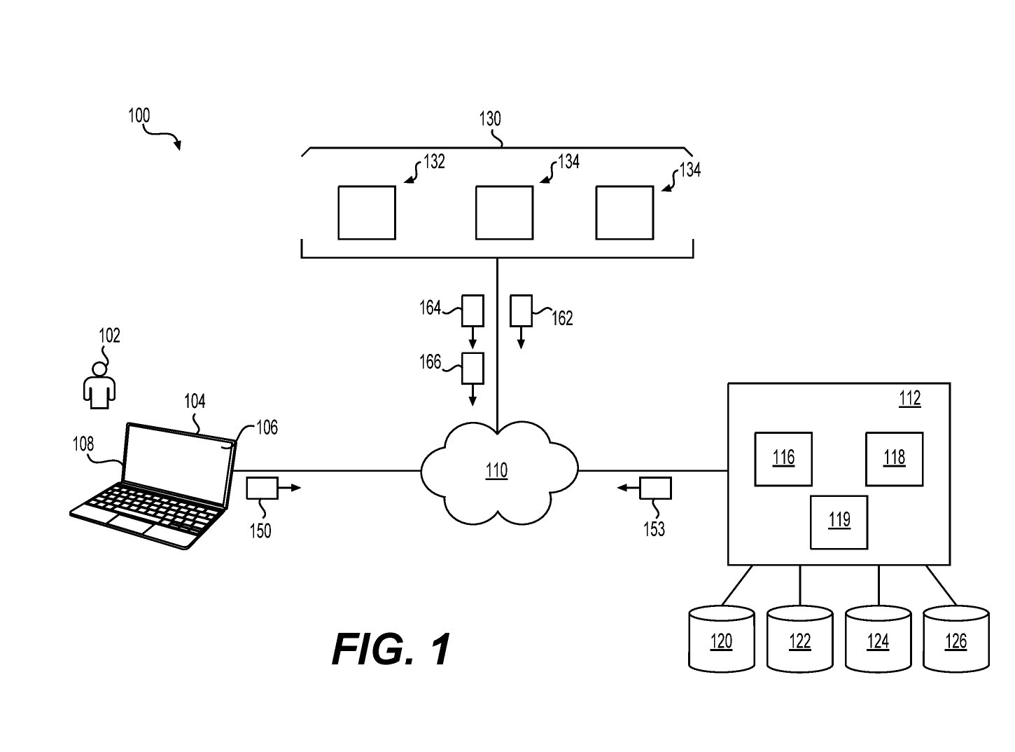

Referring to FIG. 1, there is shown a schematic diagram of a system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

Generally speaking, the system 100 is configured to provide content recommendations to a user 102 of the system 100 in a form of sets of recommended digital items to be displayed on an electronic device 104. The recommended digital items can be, but are not limited to, news articles, retail items, audiovisual items, targeted content, digital ads, and the like. The user 102 may be a subscriber to a recommendation service provided by the system 100. However, the subscription does not need to be express or paid for. For example, the user 102 can become a subscriber by virtue of downloading a recommendation application from the system 100, by registering and provisioning a log-in/password combination, by registering, by accessing a web browser, by accessing a landing page of the recommendation service provided by the system 100, and the like. As such, any system variation configured to generate content recommendations for the given user 102 can be adapted to execute embodiments of the present technology, once teachings presented herein are appreciated. Furthermore, the system 100 will be described using an example of the system 100 being a recommendation system (therefore, the system 100 can be referred to herein below as a “recommendation system 100” or a “prediction system 100”). However, embodiments of the present technology can be equally applied to other types of the systems 100, as will be described in greater detail herein below.

The system 100 comprises the electronic device 104, the electronic device 104 being associated with the user 102. As such, the electronic device 104 can sometimes be referred to as a “client device”, “end user device” or “client electronic device”. It should be noted that the fact that the electronic device 104 is associated with the user 102 does not need to suggest or imply any mode of operation—such as a need to log in, a need to be registered, or the like.

The implementation of the electronic device 104 is not particularly limited, but as an example, the electronic device 104 may be implemented as a personal computer (desktops, laptops, netbooks, etc.), a wireless communication device (such as a smartphone, a cell phone, a tablet and the like), as well as network equipment (such as routers, switches, and gateways). The electronic device 104 comprises hardware and/or software and/or firmware (or a combination thereof), as is known in the art, to execute a recommendation application 106. Generally speaking, the purpose of the recommendation application 106 is to enable the user 102 to receive (or otherwise access) recommendation items provided by the system 100. How the recommendation items are selected by the system 100 for the user 102 will be described in greater detail herein below.

How the recommendation application 106 is implemented is not particularly limited. One example of the recommendation application 106 may include a user accessing a web site associated with a recommendation service to access the recommendation application 106. For example, the recommendation application 106 can be accessed by typing in (or otherwise copy-pasting or selecting a link) a URL associated with the recommendation service. Alternatively, the recommendation application 106 can be an app downloaded from a so-called app store, such as APPSTORE™ or GOOGLEPLAY™ and installed/executed on the electronic device 104. It should be expressly understood that the recommendation application 106 can be accessed using any other suitable means.

In other embodiments, the recommendation application 106 may be implemented as a browser (for example, a GOOGLE™ browser, a YANDEX™ browser, a YAHOO!™ browser or any other proprietary or commercially available browser application). For example, the user 102 may be provided access to the recommendation service via a welcome or home page of the browser.

The electronic device 104 is communicatively coupled to a communication network 110 for accessing a server 112. In some non-limiting embodiments of the present technology, the communication network 110 can be implemented as the Internet. In other non-limiting embodiments of the present technology, the communication network 110 can be implemented differently, such as any wide-area communication network, local-area communication network, a private communication network and the like. How a communication link (not separately numbered) between the electronic device 104 and the communication network 110 is implemented will depend inter alia on how the electronic device 104 is implemented.

Merely as an example and not as a limitation, in those embodiments of the present technology where the electronic device 104 is implemented as a wireless communication device (such as a smartphone), the communication link can be implemented as a wireless communication link (such as but not limited to, a 3G communication network link, a 4G communication network link, Wireless Fidelity, or WiFi® for short, Bluetooth® and the like). In those examples where the electronic device 104 is implemented as a notebook computer, the communication link can be either wireless (such as Wireless Fidelity, or WiFi® for short, Bluetooth® or the like) or wired (such as an Ethernet based connection).

The recommendation system 100 also comprises a plurality of web resources 130 communicatively coupled to the communication network 110. Each one of the plurality of resources 130, namely a first web resource 132, a second web resource 134 and a third web resource 136, is representative of a network resource accessible by the server 112 (or the electronic device 104) via the communication network 110.

In some embodiments, a given web resource within the plurality of web resources 130 is a given web page accessible at its dedicated Universal Resource Locator (URL). For example, the given web resource can be one of the web pages operated by the CNN news agency that relates to a specific topic such as, but not limited to, politics, travel, health, entertainment, sports, international affairs and the like. Therefore, it can be said that a given web resource (such as one of: the first web resource 132, the second web resource 134, and the third web resource 136) may comprise content originating from a given web page.

In other embodiments, a given web resource within the plurality of web resources 130 is a given plurality of web pages that are hosted by a common web domain. For example, the given web resource can include all of the web pages operated by the CNN news agency since all of the web pages hosted by the CNN news agency are hosted by the common web domain operated by the CNN news agency. Therefore, it can be said that a given web resource (a first web resource 132, a second web resource 134 and a third web resource 136) may comprise the given plurality of web pages hosted by the common web domain.

Each one of the plurality of web resources 130 hosts a respective plurality of content items. For example, a given web resource may host news items that are associated with respective news articles published by the CNN news agency on the given web resource. Therefore, it can be said that content of a given web resource comprises content of given content items that are associated with the given web resource. Also, this means that content of a given content item originates from a respective web resource.

It should be noted that, in some cases, at least some of the plurality of web resources 130 may provide undesirable content. For example, at least one of the plurality of web resources 130 may provide a particular type of content, known as “click-bate” content, where a web content provider of the at least one of the plurality of web resources 130, in an attempt to draw user's clicks on their content, gives the content provocative or scandalous titles in order to capture user attention and, therefore, entice users to interact with this content. However, an operator of the recommendation service may have determined that “click-bate” content is undesirable for provision as recommended content to users of the recommendation system since, although this content will most likely be viewed/interacted with by a large number of users due to attractive titles, “click-bate” content may not be particularly relevant to these users.

In order to identify undesirable content, the operator may have determined content policies which are indicative of various types of undesirable content such “click-bate” content and/or other types of undesirable content. The other types of undesirable content may be, but are not limited to: violent content, sexually-explicit content, gore content, obscene content, and the like. How these pre-determined content policies are employed by the recommendation service will become apparent from the description herein below.

Returning to description of FIG. 1, the recommendation system 100 also comprises the server 112 that can be implemented as a conventional computer server. In an example of an embodiment of the present technology, the server 112 can be implemented as a Dell™ PowerEdge™ Server running the Microsoft™ Windows Server™ operating system. Needless to say, the server 112 can be implemented in any other suitable hardware, software, and/or firmware, or a combination thereof. In the depicted non-limiting embodiments of the present technology, the server 112 is a single server. In alternative non-limiting embodiments of the present technology, the functionality of the server 112 may be distributed and may be implemented via multiple servers.

The server 112 implements, a first machine learned algorithm (MLA) 116, a second MLA 118 and an auxiliary recommendation algorithm 119. The server 112 has access to a main database 120, an item feature database 122, a recommendable content item database 124, and a user interaction database 126.

Furthermore, in the depicted illustration, the main database 120, the item feature database 122, the recommendable content item database 124 and the user interaction database 126 are depicted as separate physical entities. This does not need to be so in each and every embodiment of the present technology. As such, some or all of the main database 120, the item feature database 122, the recommendable content item database 124 and the user interaction database 126 may be implemented in a single database. Furthermore, any one of the main database 120, the item feature database 122, the recommendable content item database 124, and the user interaction database 126 may, in itself, be split into several distributed storages.

By the same token, all (or any combination of) the first MLA 116, the second MLA 118, the auxiliary ranking algorithm 119, the main database 120, the item feature database 122, the recommendable content item database 124 and the user interaction database 126 may be implemented in a single hardware apparatus.

The main database 120 is configured to store information extracted or otherwise determined by the server 112 during processing. Generally speaking, the main database 120 may receive data from the server 112 that was extracted or otherwise determined by the server 112 during processing for temporary and/or permanent storage thereof and may provide stored data to the server 112 for use thereof.

The item feature database 122 is configured to store information related to item features associated with, for example, content items that were previously recommended by the recommendation service to its previous users and with which at least one previous user has interacted. Examples of such content items can include but are not limited to: a song to be streamed or downloaded, a document to be downloaded, a news article to be read, a product being sold, a Search Engine Result Page (SERP) and the like.

Examples of the item features include but are not limited to:
popularity of a given item amongst users of the recommendation service (for example, in case of the given item being a music track, how many times this given music track has been listened to/downloaded by users of the recommendation service);
a number of likes/purchases/downloads/clicks amongst all events associated with the given item and that have been performed via the recommendation service; and
item-inherent characteristics that are based on content of the respective content item—in case of the given item being a music track—length of the track, the genre of the track, audio-characteristic of the track (for example, tempo of the track); other item-inherent characteristics include: the price of the given item, the dimensions of the given item, the category of the given item, the producer/maker of the item, the length of the document measured in words or symbols; category/theme of the document; movie rating on a movie rating host, etc.

The recommendable content item database 124 is configured to store information/content associated with a pool of potentially recommendable content items by the recommendation service and that comprises all the content items that the recommendation service can potentially recommend to its users. Each one of the pool of potentially recommendable content items is a respective digital content item associated with respective item features being stored in the item feature database 122. The nature of one or more potentially recommendable content items within the pool of recommendable content items is not particularly limited. Some examples of the one or more potentially recommendable content items include but are not limited to digital content items such as:
a news item;
a publication;
a web resource;
a post on a social media web site;
a new item to be downloaded from an application store;
a new song (music track) to play/download from a resource;
a new movie (video clip) to play/download from a resource;
a product to be bought from a resource; and
a new document uploaded for viewing on a social media web site (such as a new photo uploaded to an INSTRAGRAM or FACEBOOK account).

The pool of potentially recommendable content items can comprise at least one item from the respective pluralities of items associated with the plurality of web resources 130, even though this does not need to be the case in each and every embodiment of the present technology.

The user interaction database 126 is configured to store information related to user events/interactions associated with previous users of the system 100. Naturally, the user events can be stored in an encrypted form. Examples of the user events include but are not limited to:
a given user of the recommendation system “scrolled over” a given item;
a given user of the recommendation system “liked” the given item;
a given user of the recommendation system shared the given item;
a given user of the recommendation system has clicked on (or otherwise selected) the given item; and
a given user of the recommendation system has purchased/ordered/downloaded the given item.

It should be expressly understood that the user events and the item features may take many forms and are not specifically limited. As such, above presented lists of non-limiting examples of the way that the user events and the item features may be implemented are just examples thereof. As such, it should be expressly understood that many other alternative implementations of the user events and the item features may be contemplated in different implementations of the present technology.

How information is obtained and stored in the item feature database 122, the recommendable content item database 124 and the user interaction database 126 is not particular limited.

For example, the information related to the item features may be obtained from a particular service that maintains information about various items available therefrom and the like; and stored in the item feature database 122. The information related to the item features may be divided into various categories representative of various types or topics of items.

The information related to the set of potentially recommendable items can be obtained by “crawling” a large variety of resources which may include, in some cases, the plurality of resources 130; and stored in the recommendable content item database 124. However, it is contemplated that the set of potentially recommendable items may not include any one of or some of content items originating from the plurality of web resources 130.

The information related to the user events may be obtained by recording previous user interactions between any one of the set of potentially recommendable items stored in the recommendable content item database 124 and some or all the users of the recommendation system; and stored in the user interaction database 126. The information related to the user events may be stored in an encrypted form.

The server 112 hosts the recommendation service and, generally speaking, is configured to (i) receive from the electronic device 104 a request 150 for recommended content and (ii) responsive to the request 150, generate a response 153 comprising a given ranked recommended list of content items. The given ranked recommended list of content items transmitted to the electronic device 104 is ranked at least partially in a user-specific manner and represents a personalized content recommendation that is specific to the user 102. However, in addition to being ranked at least partially in the user-specific manner, the given ranked recommended list of content items may comprise some content items associated with potentially undesirable content that may be demoted to lower ranks in the given ranked recommended list of content items as it will be further described herein below.

In some embodiments of the present technology, the request 150 may be generated in response to the user 102 providing an explicit indication of a user desire to receive recommended content such as by clicking a button from the recommendation application 106. Therefore, the request 150 for a given set of recommendation items can be thought of as “an explicit request” in a sense of the user 102 expressly providing a request for the given set of recommendation items.

In other embodiments, the request 150 can be generated in response to the user 102 providing an implicit indication of the user desire to receive recommended content. In some embodiments of the present technology, the request 150 can be generated in response to the user 102 starting the recommendation application 106.

In yet further embodiments of the present technology, the request 150 can be generated even without the user 102 providing either explicit or implicit indication of the user desire to receive recommended content. For example, in those embodiments of the present technology where the recommendation application 106 is implemented as the browser, as previously mentioned, the request 150 can be generated in response to the user 102 opening the browser application and can be generated, for example, without the user 102 executing any additional actions other than activating the browser application. As another example, the request 150 can be generated in response to the user 102 opening a new tab of the already-opened browser application and can be generated, for example, without the user 102 executing any additional actions other than activating the new browser tab. In other words, the request 150 can be generated even without the user 102 knowing that the user 102 may be interested in obtaining the given set of recommendation items.

As another example, the request 150 may be generated in response to the user 102 selecting a particular element of the browser application and can be generated, for example, without the user 102 executing any additional actions other than selecting/activating the particular element of the browser application.

Examples of the particular element of the browser application include but are not limited to:
an address line of the browser application bar;
a search bar of the browser application and/or a search bar of a search engine web site accessed in the browser application;
an omnibox (combined address and search bar of the browser application);
a favorites or recently visited network resources pane; and
any other pre-determined area of the browser application interface or a web resource displayed in the browser application.

Upon receiving the request 150, the server 112 is configured to receive an indication of previous user interactions of the user 102 with the recommendation service. For example, the server 112 may identify the user 102 based on the request 150 and may retrieve the indication of the previous user interactions of the user 102 from the user interaction database 126.

The server 112 is also configured to receive an indication of content (or the content itself) from the plurality of web resources 130. To that end, the server 112 may receive a respective data packet from each one of the plurality of web resources 130. For example, the server 112 may receive over the communication network 110 (i) a first data packet 162 from the first web resource 132, (ii) a second data packet 164 from the second web resource 134 and (i) a third data packet 166 from the third web resource 136. It should be noted that in alternative embodiments of the present technology, the first data packet 162, the second data packet 164, and the third data packet 166 are received in an offline mode (i.e. before receiving the request 150), such as once a day, once every hour or the like.

In embodiments where a given web resource is a given web page, the respective data packet received by the server 112 may comprise content associated with the given web page. For example, the respective data packet may comprise computer files representative of the given web page, which may be written in Hypertext Markup Language (HTML) or in any other suitable markup language, as well as computer files representative of web elements (such as, but not limited to, style sheets, scripts, images and the like) that are associated with the computer files representative of the given web page.

In other embodiments where a given web resource is a given plurality of web pages that are hosted by a given common web domain, the respective data packet received by the server 112 may comprise content associated with each web page of the given plurality of web pages.

The server 112 may be configured to store the content of each one of the plurality of web resources in the main database 120. For example, upon receiving the first, second and third data packets 162, 164 and 166, the server 112 may store the content of each one of the first, second and third data packets 162, 164 and 166 in the main database 120 for further processing thereof.

Irrespective of whether each web resource is the given web page or the given plurality of web pages hosted by the given common domain, the server 112 may be configured to parse the web resource content in each data packet in order to identify given content items hosted by the plurality of web resources 130 and extract content associated with each one of the given content items.

Generally speaking, parsing refers to execution of syntactic and/or lexical analyses of the computer code for facilitating extraction of particular components and/or other semantic information from the computer codes. During parsing, a parsing algorithm may be employed by the server 112 and may be inputted with computer files for outputting or building data structures, in a form of parse trees, abstract syntax trees or other hierarchical structures, which define structural representations of the inputted computer files. Inputted computer files may be written in various computer languages such as markup languages, for example.

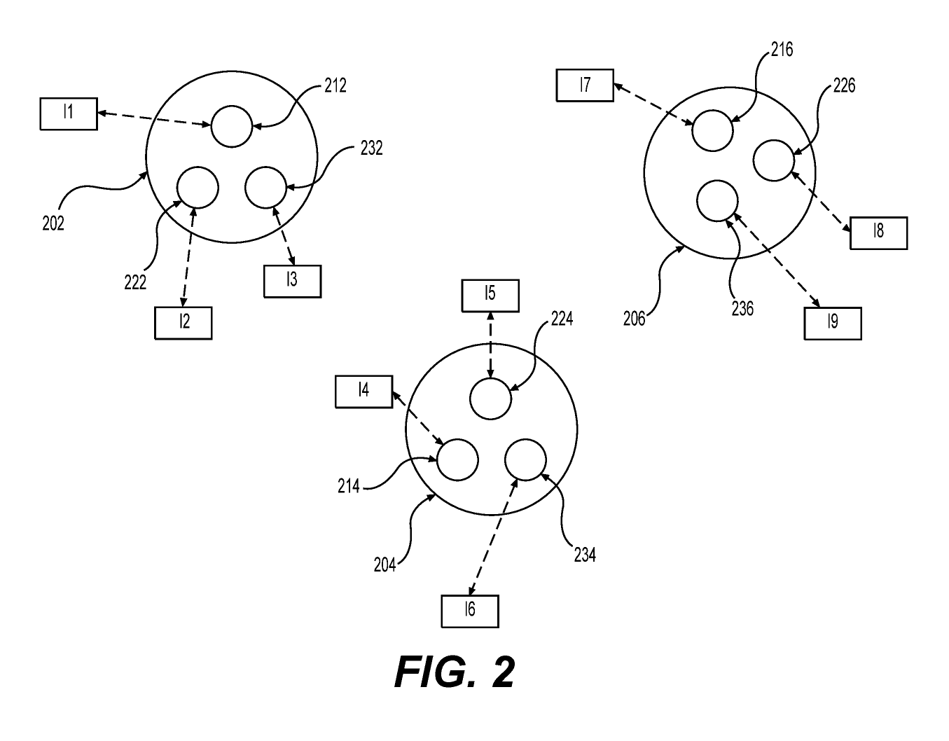

With reference to a non-limiting embodiment depicted in FIG. 2, let it be assumed that the first data packet 162 comprises first web resource content 202 associated with and originating from the first web resource 132. The second data packet 164 comprises second web resource content 204 associated with and originating from the second web resource 134. The third data packet 166 comprises third web resource content 206 associated with and originating from the third web resource 136.

The server 112 may be configured to parse each one of the first, second and third web resource content 202, 204 and 206 for identifying respective content items and extracting content associated with each one of the respective content items.

By parsing the first web resource content 202, the server 112 may identify three content items I1, I2 and I3 associated with and originating from the first web resource 132. The server 112 also extracts first content 212 associated with the content item I1, second content 222 associated with the content item I2 and third content 232 associated with the content item I3. It should be understood that the first, second and third content 212, 222 and 232 of content items I1, I2 and I3, respectively, originate from the first web resource 132. It can be said that the first content 212 is representative of content of the content item I1, the second content 222 is representative of content of the content item I2 and the third content 232 is representative of content of the content item I3.

By parsing the second web resource content 204, the server 112 may identify three content items I4, I5 and I6 associated with and originating from the second web resource 134. The server 112 also extracts fourth content 214 associated with the content item I4, fifth content 224 associated with the content item I5 and sixth content 234 associated with the content item I6. It should be understood that the fourth, fifth and sixth content 214, 224 and 234 of content items I4, I5 and I6, respectively, originate from the second web resource 134. It can be said that the fourth content 214 is representative of content of the content item I4, the fifth content 224 is representative of content of the content item I5 and the sixth content 234 is representative of content of the content item I6.

By parsing the third web resource content 206, the server 112 may identify three content items I7, I8 and I9 associated with and originating from the third web resource 136. The server 112 also extracts seventh content 216 associated with the content item I7, eighth content 226 associated with the content item I8 and ninth content 236 associated with the content item I9. It should be understood that the seventh, eighth and ninth content 216, 226 and 236 of content items I7, I8 and I9, respectively, originate from the third web resource 136. It can be said that the seventh content 216 is representative of content of the content item I7, the eighth content 226 is representative of content of the content item I8 and the ninth content 236 is representative of content of the content item I9.

Although in the non-limiting embodiment depicted in FIG. 2 the server 112 identified three content items originating from a each one of the plurality of web resource 130, it should be understood that, in other cases, the server 112 may identify fewer than or more than three content items originating from a any one of the plurality of web resource 130 without departing from the scope of the present technology. It should be also noted that a number of content items extracted form a given web resource can be different from the number of content items extracted from a different web resource.

The server 112 is configured to analyze each one of the content 212, 222, 232, 214, 224, 234, 216, 226 and 236 in order to determine item features associated with each one of the content items I1, I2, I3, I4, I5, I6, I7, I8 and I9, respectively. As previously mentioned, each one of the content 212, 222, 232, 214, 224, 234, 216, 226 and 236 is representative of content of a respective one of the content items I1, I2, I3, I4, I5, I6, I7, I8 and I9. As such, the server 112 may analyze the content of a given content item in order to determine item-inherent characteristics that are based on content of the respective content item.

In some cases, at least some of the content items I1, I2, I3, I4, I5, I6, I7, I8 and I9 may have been previously recommended by the recommendation service to its previous users and with which at least one previous user has interacted. In other words, the at least some of the content items may have been previously stored in the recommendable content item database 124 for which respectively associated item features have been previously stored in the item feature database 122. In these cases, the server 112 may be configured to retrieve from the item feature database 122 other item features, in addition to the item-inherent characteristics, associated with each one of the at least some content items.

Based on the item features of each of the content items I1, I2, I3, I4, I5, I6, I7, I8 and I9 and the indication of previous user interactions associated with the user 102, the server 112 is configured to generate a respective user-specific ranking score for each one of the content items I1, I2, I3, I4, I5, I6, I7, I8 and I9.

The generation of the user-specific ranking scores can be executed in many ways. For example, in one embodiment, the server 112 may employ the first MLA 116 for generating a respective user-specific ranking score for each one of the content items I1, I2, I3, I4, I5, I6, I7, I8 and I9. The first MLA 116 is referred herein as a “user-specific-ranking” MLA since the first MLA 116 generates user-specific ranking scores that are indicative of estimated relevance of respective content items to a specific user (in this case, they are indicative of the respective estimated relevance of the content items I1, I2, I3, I4, I5, I6, I7, I8 and I9 to the user 102).

How the first MLA 116 of the server 112 is trained and configured to generate user-specific ranking scores associated with content items for the user 102 is disclosed in a patent application Ser. No. 15/607,555, filed on May 29, 2017 and entitled “METHOD AND APPARATUS FOR TRAINING A MACHINE LEARNING ALGORITHM (MLA) FOR GENERATING A CONTENT RECOMMENDATION IN A RECOMMENDATION SYSTEM AND METHOD AND APPARATUS FOR GENERATING THE RECOMMENDED CONTENT USING THE MLA”, the entirety of which is incorporated herein by reference.

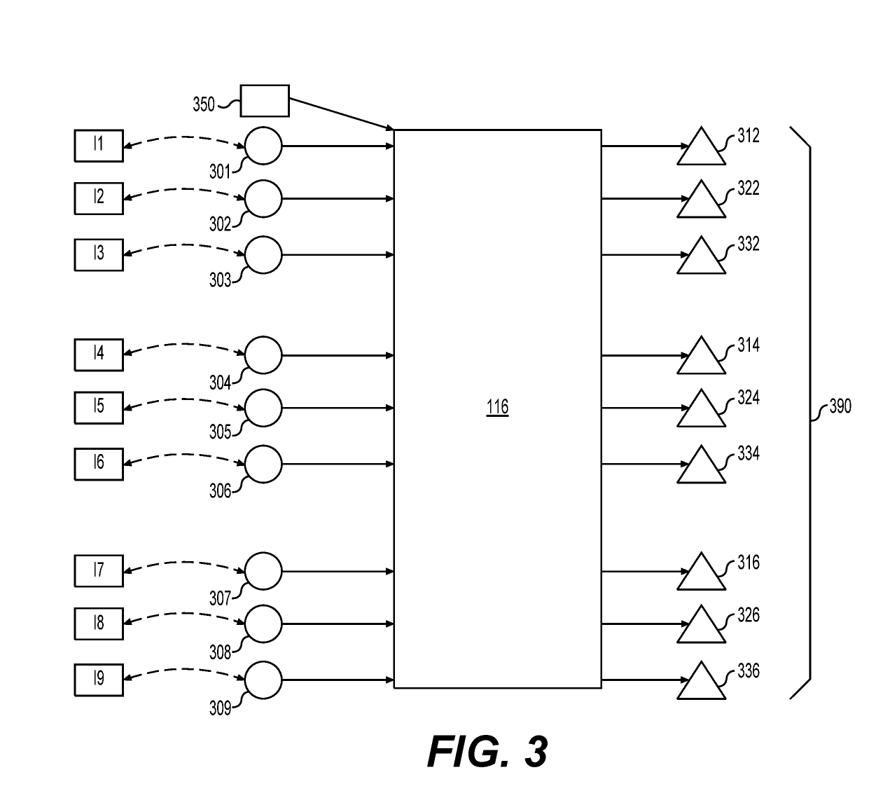

With reference to FIG. 3, there is depicted an indication 350 of previous user interactions of the user 102 with the recommendation service as well as each item feature information representative of the respective item features associated with a respective one of the content items I1, I2, I3, I4, I5, I6, I7, I8 and I9. The first MLA 116 (user-specific-ranking MLA) is inputted with the indication 350 of previous user interactions and the feature information associated with each one of the content items I1, I2, I3, I4, I5, I6, I7, I8 and I9 and outputs a respective user-specific ranking score for each one of the content items I1, I2, I3, I4, I5, I6, I7, I8 and I9.

As such, the first MLA 116:
Based on the indication 350 and feature information 301 representative of item features of the content item I1, generates a first user-specific ranking score 312;
Based on the indication 350 and feature information 302 representative of item features of the content item I2, generates a second user-specific ranking score 322;
Based on the indication 350 and feature information 303 representative of item features of the content item I3, generates a third user-specific ranking score 332;
Based on the indication 350 and feature information 304 representative of item features of the content item I4, generates a fourth user-specific ranking score 314;
Based on the indication 350 and feature information 305 representative of item features of the content item I5, generates a fifth user-specific ranking score 324;
Based on the indication 350 and feature information 306 representative of item features of the content item I6, generates a sixth user-specific ranking score 334;
Based on the indication 350 and feature information 307 representative of item features of the content item I7, generates a seventh user-specific ranking score 316;
Based on the indication 350 and feature information 308 representative of item features of the content item I8, generates an eighth user-specific ranking score 326; and
Based on the indication 350 and feature information 309 representative of item features of the content item I9, generates a ninth user-specific ranking score 336.

The server 112 may be configured to store each user-specific ranking score associated with the respective content item in the main database 120 for future processing thereof. In other words, the server 112 may store in the main database 120 a plurality of user-specific ranking scores 390 with associations to the respectively associated content items.

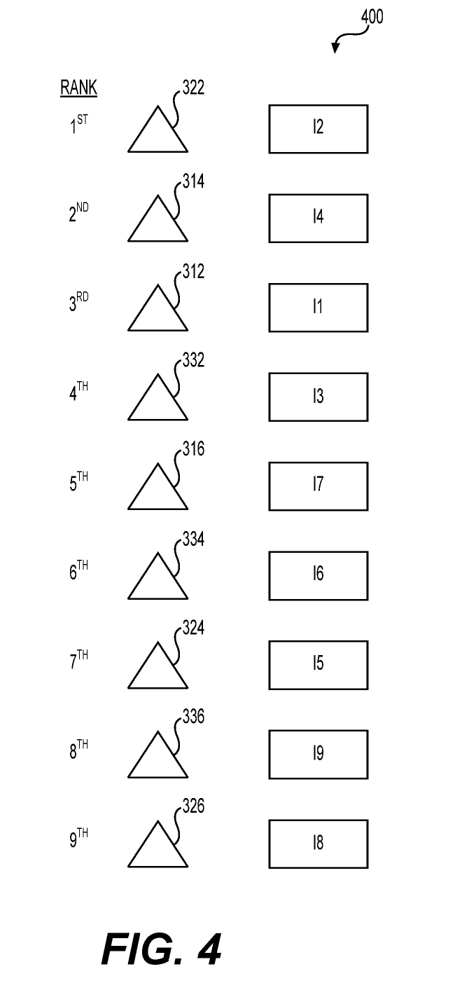

With reference to FIG. 4, the first MLA 116 implemented by the server 112 also generates a ranked list of recommendable content items 400 which, in this case, comprises the content items I1, I2, I3, I4, I5, I6, I7, I8 and I9 that are ranked based on their respectively associated user-specific ranking scores generated by the first MLA 116. A given content item with the highest user-specific ranking score of the plurality of user-specific ranking scores 390 will be associated with the highest rank in the ranked list of recommendable content items 400 while another given content item associated with the lowest user-specific ranking score of the plurality of user-specific ranking scores 390 will be associated with the lowest rank in the ranked list of recommendable content items 400.

Let it be assumed that, based on the respectively associated user-specific ranking scores, the content item:
I2 is ranked 1^{st} in the ranked list of recommendable content items 400;
I4 is ranked 2^{nd} in the ranked list of recommendable content items 400;
I1 is ranked 3^{rd} in the ranked list of recommendable content items 400;
I3 is ranked 4^{th} in the ranked list of recommendable content items 400;
I7 is ranked 5^{th} in the ranked list of recommendable content items 400;
I6 is ranked 6^{th} in the ranked list of recommendable content items 400;
I5 is ranked 7^{th} in the ranked list of recommendable content items 400;
I9 is ranked 8^{th} in the ranked list of recommendable content items 400; and
I8 is ranked 9^{th} in the ranked list of recommendable content items 400.

It should be noted that the content items I1, I2, I3, I4, I5, I6, I7, I8 and I9 are ranked in the ranked list of recommendable content items 400 based on their estimated relevance to the user 102. For example, the content item I2 is associated with the highest estimated relevance to the user 102, since the second user-specific ranking score 322 associated with the content item I2 is the highest user-specific ranking score of the plurality of user-specific ranking scores 390. In another example, the content item I8 is associated with the lowest estimated relevance to the user 102, since the eighth user-specific ranking score 326 associated with the content item I8 is the lowest user-specific ranking score of the plurality of user-specific ranking scores 390.

However, as previously mentioned, at least some content items amongst the content items I1, I2, I3, I4, I5, I6, I7, I8 and I9 may be associated with potentially undesirable content for users of the recommendation service. Generally speaking, even though a given content item is estimated to be highly relevant for a given user, this given content item may still be associated with potentially undesirable content for recommendation to users of the recommendation service based on the pre-determined content policies. For example, a given “click-bate” content item may be estimated to be highly relevant for a given user since it may be associated with a large amount of past user interactions (e.g., clicks). Thus, the given “click-bate” content item may have a high relevancy score which will result in the “click-bate” content item being ranked higher based on relevancy than it should be since, in this case where the content is “click-bate” content, the amount of user interactions is a flawed indicator of its relevancy to the given user.

Therefore, it is contemplated that, in some embodiments of the present technology, instead of providing the ranked list of recommendable content items 400 as a given ranked recommended list of content items to the user 102, the server 112 may be configured to demote ranks of at least some content items if they are likely to be associated with undesirable content.

To that end, the server 112 may be configured to employ the second MLA 118. The second MLA 118 during its in-use phase is configured to generate demoting scores for content items. In order to generate demoting scores for content items, the second MLA 118 has been trained during its training phase. How the second MLA 118 is trained during its training phase and how it is configured to generate demoting scores during its in-use phase will now be described in turn.

### Training Phase of the Second MLA 118

Generally speaking, the second MLA 118 is trained to receive a given content item and to output, for the inputted given content item, a demoting score indicative of a degree of undesirability of the inputted content. Broadly speaking, the MLA 118 is configured to output the demoting score based on: (i) content of a given content item; (ii) content of a plurality/all content items of the web resource; and (iii) combination of (i) and (ii).

Thus, the training of the second MLA 118 may be at least partially based on the pre-determined content policy(ies) having been pre-determined by the operator of the recommendation service. As previously mentioned, the pre-determined content policies may be indicative of various types of undesirable content such as “click-bate” content, violent content, sexually-explicit content, gore content, obscene content, and the like.

In some embodiments, the second MLA 118 may be trained based on “undesired content indicators” which are based in turn on the pre-determined content policies. The undesired content indicators may be representative of heuristic rules which, when confirmed following the analysis of a given content item, are indicative of the given content item being of a content type that is included in the pre-determined content policies. For example, the undesired content indicators may be representative of heuristic rules such as, but not limited to:
Does the content comprise words or sentences that are associated with any given undesirable content?
Does the content comprise words or sentences that are associated with “click-bate” content?
Does the content comprise words or sentences that are associated with violent content?
Does the content comprise words or sentences that are associated with sexually-explicit content?
Does the content comprise words or sentences that are associated with gore content?
Does the content comprise words or sentences that are associated with obscene content?
Does the content comprise words or sentences that are associated with another type of undesirable content?
Does the title section of the content comprise words or sentences that are associated with undesirable content?
Does the content comprise pop-up window triggers?
Does the content comprise more than a threshold number of advertising elements?

In other embodiments, the second MLA 118 may be trained based on pre-determined training data which has been generated based on the pre-determined content policies. The training data may be generated by the server 112 following a rating of a plurality of training content (e.g., for example, content of a plurality of training content items) by a plurality of assessors. For example, each one of the plurality of assessors may be presented with such training content and, in response, each one of the plurality of assessors may rate the presented training content based on the pre-determined content policies. As such, the server 112 may generate a plurality of “training content-assessor rating” pairs which are used as the training data for training the second MLA 118.

When the “untrained” second MLA 118 is inputted with the training data during the training phase thereof, the second MLA 118 learns, in a sense, relationships and/or data patterns between the training content and respectively associated assessor ratings, which are based on the pre-determined content policies, in order to (i) classify given content inputted therein during the in-use phase and (ii) generate a given demoting score for the given content based on the classification.

The second MLA 118 may be trained to associate a given content inputted therein with at least one content class amongst a plurality of content classes. In some embodiments, the plurality of content classes may comprise (i) at least one undesirable-content class and (ii) at least one neutral-content class. The at least one undesirable-content class may be associated with a given type of undesirable content included in the pre-determined content policies, while content not associated with any type of undesirable content may be associated with the at least one neutral-content class. In other embodiments, the at least one undesirable-content class may comprise a set of undesirable-content classes where each undesirable-content class in the set of undesirable-content classes is associated with a respective type of undesirable content included in the pre-determined content policies. For example, a first undesirable-content class of the set of undesirable-content classes may be associated with “click-bate” content while a second undesirable-content class of the set of undesirable-content classes may be associated with sexually-explicit content.

When a given content is classified by the second MLA 118 into one of the plurality of content classes, the second MLA 118 may generate a given demoting score for the given content based on which one respective content class of the plurality of content classes the given content is classified into.

It is contemplated that the second MLA 118 may generate different demoting scores for content depending on the respective content class to which the content is classified. For example, the second MLA 118 may generate a first demoting score having a first value for a first content if the first content is associated with a first undesirable-content class and a second demoting score having a second value for the first content if the first content is associated with a second undesirable-content class. In another example, the second MLA 118 may generate another demoting score having a value of zero for the first content if the first content is associated with the neutral-content class of then plurality of content classes.

The second MLA 118 is referred herein as a “user-independent-classifying” MLA since, unlike the first MLA 116, the second MLA 118 was not trained on and does not use information associated with users of the recommendation service for generating the demoting scores. The second MLA 118 generates demoting scores in a user-independent manner and on a content-specific basis, and not on a user-specific basis.

### In-Use Phase of the Second MLA 118

During the in-use phase of the second MLA 118, the server 112 is configured to input content of each of the content items I1, I2, I3, I4, I5, I6, I7, I8 and I9 into the second MLA 118 which outputs a respective demoting score for each one of the content items I1, I2, I3, I4, I5, I6, I7, I8 and I9.

In one embodiment, the second MLA 118 may be configured to generate a given demoting score for a given content item based on the content of the given content item. For example, the second MLA 118 may generate a given demoting score for the content item I1 based on the first content 212. In another example, the second MLA 118 may generate a given demoting score for the content item I9 based on the ninth content 236. In this embodiment, it can be said that the second MLA 118 may be configured to generate demoting scores on an item-by-item basis such that each demoting score is based on the content of each respective content item only.

In another embodiment, the second MLA 118 may be configured to generate a given demoting score for a given content item based on an aggregate of content of all content items originating from a given web resource. For example, the second MLA 118 may generate a given demoting score for the content item I1 based on an aggregate of the first, second and third content 212, 222 and 223. In another example, the second MLA 118 may generate a given demoting score for the content item I2 based on the aggregate of the first, second and third content 212, 222 and 223. In yet another example, the second MLA 118 may generate a given demoting score for the content item I3 based on the aggregate of the first, second and third content 212, 222 and 223. This means that the second MLA 118 may generate an identical demoting score for each one of the content items I1, I2 and I3 since they originate from a same web resource. In this embodiment, it can be said that the second MLA 118 may be configured to generate demoting scores based on a web resource-by-web resource basis such that each demoting score is based on the aggregate of content of all content items originating from a same web resource. In some embodiments, the application of the web resource-by-web resource basis ranking results in all content items from a given host being demoted using the same demoting score.

In other embodiments, the second MLA 118 may be configured to generate demoting scores on a combination of an item-by-item basis and on a web resource-by-web resource basis. For example, the second MLA 118 may generate a given item-by-item demoting score for the content item I1 based on the first content 212 and a given web resource-by-web resource demoting score for the content item I1 based on the first, second and third content 212, 222 and 223. As a result, the second MLA 118 may generate a given demoting score for the content item I1 as a weighted sum of the given item-by-item demoting score and of the given web resource-by-web resource demoting score of the content item I1.

In these embodiments, it can be said that the second MLA 118 may be configured to generate demoting scores on a hybrid item-web resource basis such that each demoting score is based on (i) the content of each respective content item and (ii) the aggregate of content of all content items originating from a same web resource. The weights applied to a given item-by-item demoting score and to a given web resource-by-web resource demoting score of each respective content item in each respective weighted sum may have been pre-determined by the operator of the recommendation service.

Irrespective of how each demoting score is generated by the second MLA 118, a given demoting score associated with a respective content item is indicative of a degree of undesirability of content originating from the respective web resource.

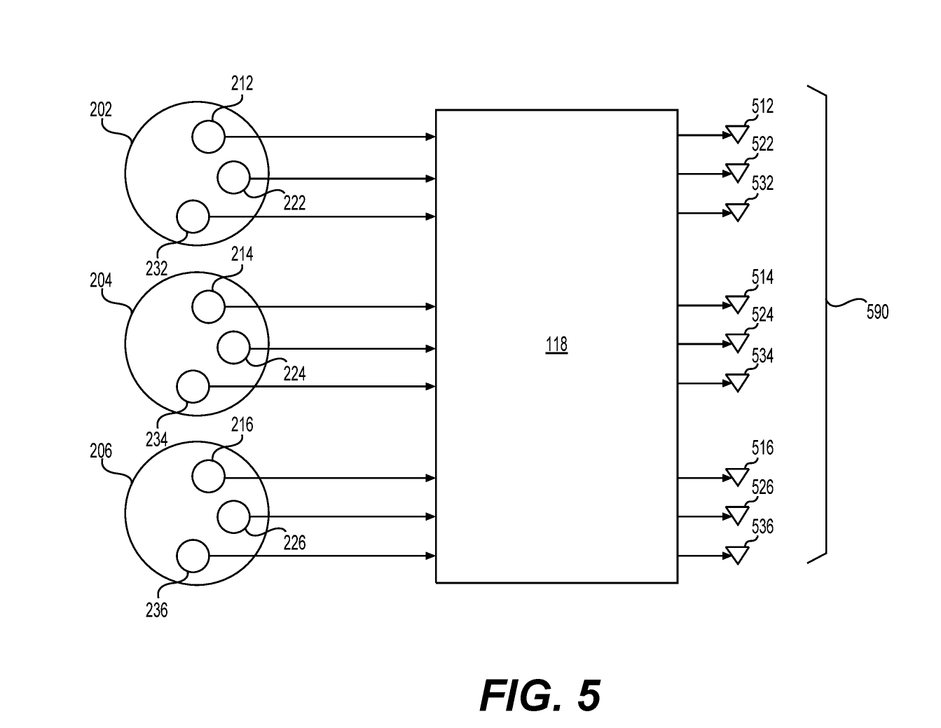

With reference to FIG. 5, the second MLA 118 generates:
a first demoting score 512 for the content item I1;
a second demoting score 522 for the content item I2;
a third demoting score 532 for the content item I3;
a fourth demoting score 514 for the content item I4;
a fifth demoting score 524 for the content item I5;
a sixth demoting score 534 for the content item I6;
a seventh demoting score 516 for the content item I7;
an eighth demoting score 526 for the content item I8; and
a ninth demoting score 536 for the content item I9.

The server 112 may be configured to store each demoting score associated with the respective content item in the main database 120 for future processing thereof. In other words, the server 112 may store in the main database 120 a plurality of demoting scores 590 with associations to the respectively associated content items.

The server 112 is also configured to generate a respective adjusted ranking score for each one of the content items I1, I2, I3, I4, I5, I6, I7, I8 and I9. The server 112 is configured to generate for a given content item a respective adjusted ranking score based on a respective user-specific ranking score of the plurality of user-specific ranking scores 390 and a respective demoting score of the plurality of demoting scores 590.

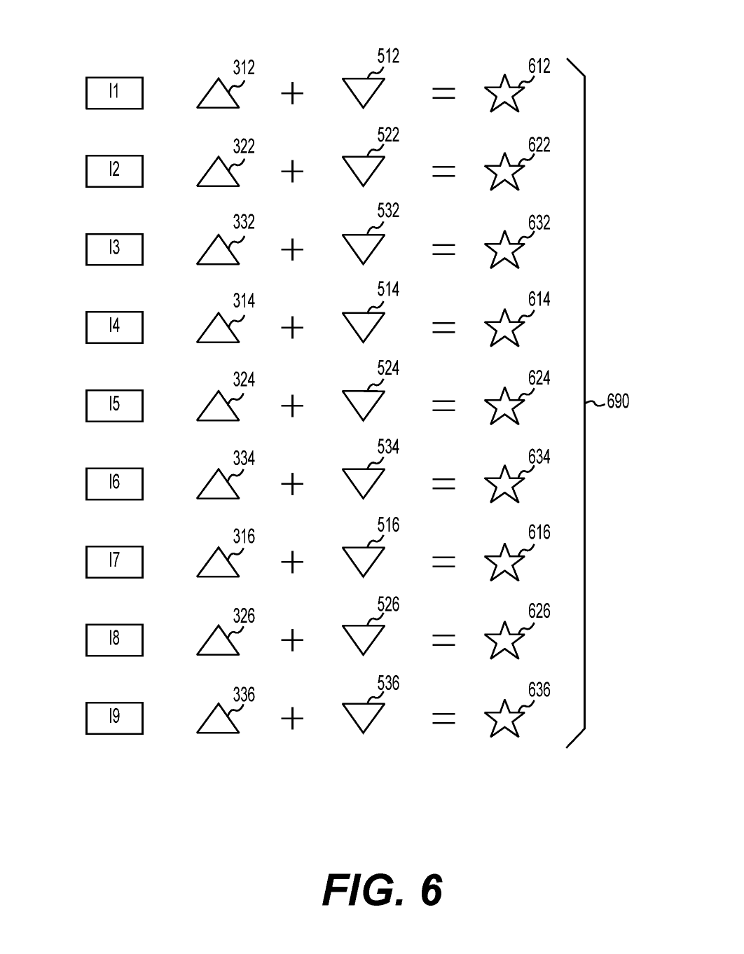

With reference to FIG. 6, the server 112 generates:
for the content item I1, a first adjusted ranking score 612 based on (i) the first user-specific ranking score 312 and (ii) the first demoting score 512;
for the content item I2, a second adjusted ranking score 622 based on (i) the second user-specific ranking score 322 and (ii) the second demoting score 522;
for the content item I3, a third adjusted ranking score 632 based on (i) the third user-specific ranking score 332 and (ii) the third demoting score 532;
for the content item I4, a fourth adjusted ranking score 614 based on (i) the fourth user-specific ranking score 314 and (ii) the fourth demoting score 514;
for the content item I5, a fifth adjusted ranking score 624 based on (i) the fifth user-specific ranking score 324 and (ii) the fifth demoting score 524;
for the content item I6, a sixth adjusted ranking score 634 based on (i) the sixth user-specific ranking score 334 and (ii) the sixth demoting score 534;
for the content item I7, a seventh adjusted ranking score 616 based on (i) the seventh user-specific ranking score 316 and (ii) the seventh demoting score 516;
for the content item I8, an eighth adjusted ranking score 626 based on (i) the eighth user-specific ranking score 326 and (ii) the eighth demoting score 526; and
for the content item I9, a ninth adjusted ranking score 636 based on (i) the ninth user-specific ranking score 336 and (ii) the ninth demoting score 536.

The server 112 may be configured to store each adjusted ranking score associated with the respective content items in the main database 120 for future processing thereof. In other words, the server 112 may store in the main database 120 a plurality of adjusted ranking scores 690 with associations to the respectively associated content items.

It can be said that each adjusted ranking score is generated at least partially in a user-specific manner and at least partially in a user-independent manner. In other words, each adjusted ranking score is generated at least partially based on previous user interactions of a specific user (the user-specific portion) and on content originating from the web resource of a respective content item (the user-independent portion).

It should be noted that, in some implementations, demoting scores and user-specific ranking scores may be of opposite signs. Put another way, a given adjusted ranking score may be inferior to the respective user-specific ranking score. Content items ranked based on the respective user-specific ranking scores may not preserve their respective ranks when ranked based on the respective adjusted ranking scores. Therefore, ranks of at least some content items may be demoted if the content items are ranked based on the adjusted ranking scores in comparison to their ranks if the content items are ranked based on the user-specific ranking scores.

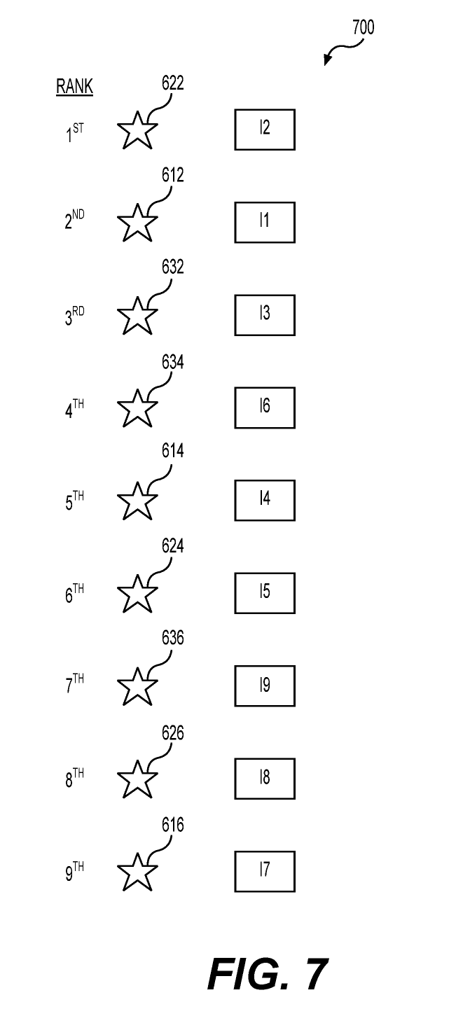

With reference to FIG. 7, the server 112 is also configured to generate a modified ranked list of recommendable content items 700. The server 112 is configured to generate the modified ranked list of recommendable content items 700 based on the content items I1, I2, I3, I4, I5, I6, I7, I8 and I9 and the respectively associated adjusted ranking scores of the plurality of adjusted ranking scores 690.

A given content item with the highest adjusted ranking score of the plurality of adjusted ranking scores 690 will be associated with the highest rank in the modified ranked list of recommendable content items 700 while another given content item associated with the lowest adjusted ranking score of the plurality of adjusted ranking scores 690 will be associated with the lowest rank in the modified ranked list of recommendable content items 700.

Let it be assumed that, based on the respectively associated adjusted ranking scores, as depicted in FIG. 7, the content item:
I2 is ranked 1^{st} in the modified ranked list of recommendable content items 700;
I1 is ranked 2^{nd} in the modified ranked list of recommendable content items 700;
I3 is ranked 3^{rd} in the modified ranked list of recommendable content items 700;
I6 is ranked 4^{th} in the modified ranked list of recommendable content items 700;
I4 is ranked 5^{th} in the modified ranked list of recommendable content items 700;
I5 is ranked 6^{th} in the modified ranked list of recommendable content items 700;
I9 is ranked 7^{th} in the modified ranked list of recommendable content items 700;
I8 is ranked 8^{th} in the modified ranked list of recommendable content items 700; and
I7 is ranked 9^{th} in the modified ranked list of recommendable content items 700.

It should be noted that the content items in the modified ranked list of recommendable content items 700 are ranked amongst each other by taking into account simultaneously (i) the estimated relevance of each respective content item and (ii) the degree of undesirability of content originating from the web resource of each respective content item.

The server 112 may be configured to store the modified ranked list of recommendable content items 700 in the main database 120 for future processing thereof. In other words, the server 112 may store in the main database 120 the content items I1, I2, I3, I4, I5, I6, I7, I8 and I9 in association with their respective ranks in the modified ranked list of recommendable content items 700.

With reference to FIGS. 4 and 7, it should be noted that the ranks of at least some content items in the modified ranked list of recommendable content items 700 are different from their respective ranks in the ranked list of recommendable content items 400. For example, the content item I4 is ranked 2^{nd} in the ranked list of recommendable content items 400 while being ranked 5^{th} in the modified ranked list of recommendable content items 700. In another example, the content item I7 is ranked 5^{th} in the ranked list of recommendable content items 400 while being ranked 9^{th} in the modified ranked list of recommendable content items 700. This rank demotion, from their given ranks in the ranked list of recommendable content items 400 to their adjusted ranks in the modified ranked list of recommendable content items 700, of the content items I4 and I7 is indicative of the content items I4 and I7 being likely associated with undesirable content.

The server 112 is also configured to trigger a presentation of a given ranked recommended list of content items to the user 102 on the electronic device 104 as the ranked recommended content. The given ranked recommended list of content items, in some embodiments, can be the modified ranked list of recommendable content items 700. In other words, in some embodiments, the server 112 may be configured to trigger the presentation of the modified ranked list of recommendable items 700 to the user as the ranked recommended content. As such, the server 112 may trigger the presentation of the content items I4 and I7 to the user according to their respective adjusted ranks in the modified ranked list of recommendable content items 700.

For example, the server 112 can generate a data packet, such as the response 153, which in this case comprises information indicative of the modified ranked list of recommendable content items 700 and instructions for triggering the presentation thereof by the electronic device 104. The server 112 may transmit the response 153 to the electronic device 104 via the communication network 110 for triggering the presentation of the modified ranked list of recommendable content items 700 to the user 102.

In other embodiments, prior to generating and transmitting the response 153, the server 112 may be configured to furnish the modified ranked list of recommendable content items 700 to the auxiliary recommendation algorithm 119 (see FIG. 1) for selecting content items from the modified ranked list of recommendable content items 700 to be included in the given ranked recommended list of content items.

For example, the auxiliary recommendation algorithm 119 may be configured to select content items, from the modified ranked list of recommendable content items 700 to be included in the given ranked recommended list of content items, that are associated with respective adjusted ranking scores that are superior to a pre-determined adjusted ranking score threshold. The pre-determined adjusted ranking score threshold may have been determined by the operator of the recommendation service.

The auxiliary recommendation algorithm 119 may determine that the content items I2, I1, I3, I6, I4 and I5 are associated with respective adjusted ranking scores that are superior to the pre-determined adjusted ranking score threshold. The auxiliary recommendation algorithm 119 may determine that the content items I9, I8 and I7 are associated with respective adjusted ranking scores that are inferior to the pre-determined adjusted ranking score threshold. As such, the auxiliary recommendation algorithm 119 may select the I2, I1, I3, I6, I4 and I5 from the modified ranked list of recommendable content items 700 and may include them into the given ranked list of recommended content items according to their respective ranked order in the modified ranked list of recommendable content items 700.

Therefore, the server 112 can generate the response 153 which in this case comprises information indicative of the ranked recommended list of content items comprising the content items I2, I1, I3, I6, I4 and I5 (ranked according to their respective ranks in modified ranked list of recommendable content items 700) and instructions for triggering the presentation thereof by the electronic device 104. The server 112 may transmit the response 153 to the electronic device 104 via the communication network 110 for triggering the presentation of the ranked recommended list of content items to the user 102.

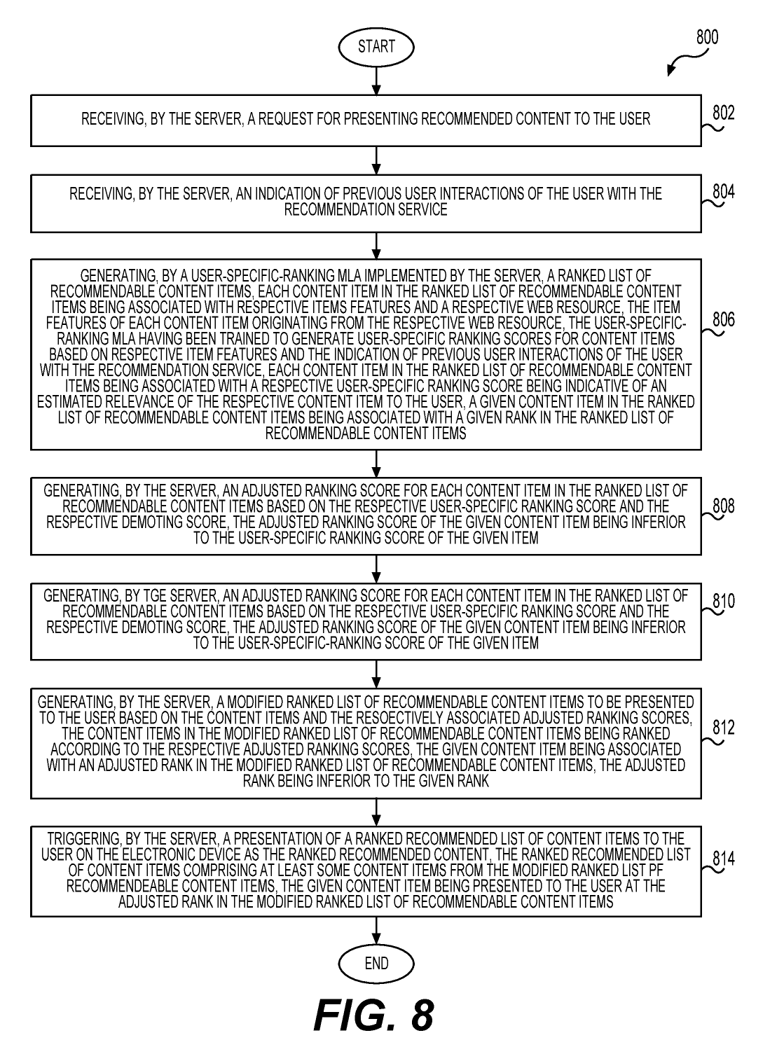

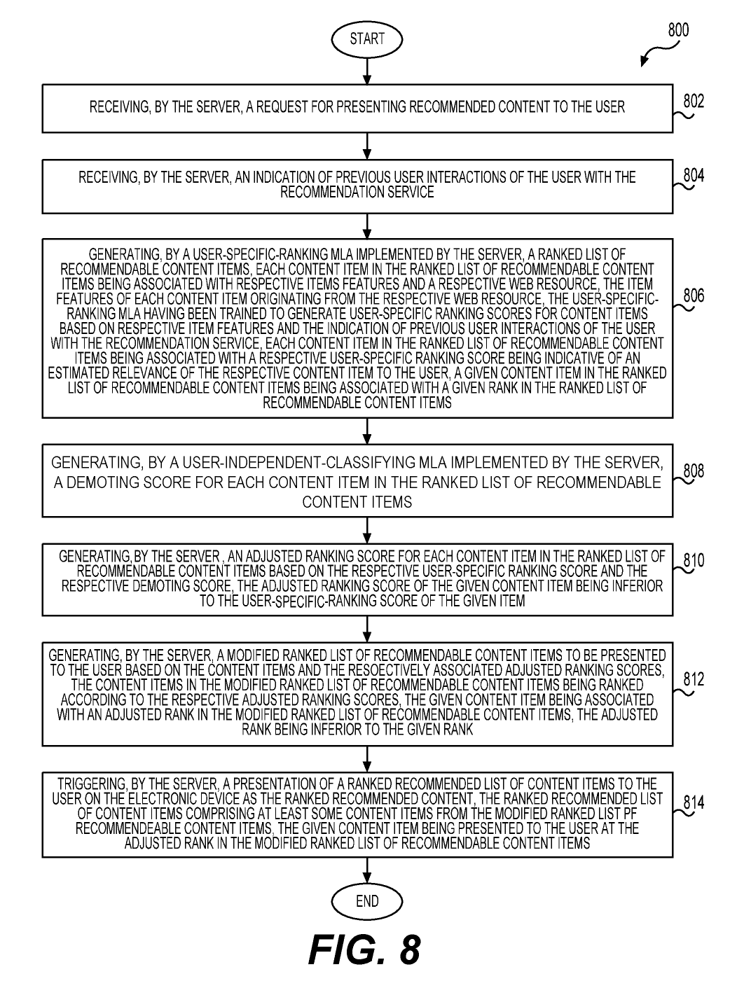

With reference to FIG. 8, the server 112 may be configured to execute a method 800 of presenting a given recommended content item to a given user on a respective electronic device and where the given recommended content item is associated with potentially undesirable content. The method 800 will now be described in further detail herein below.

### Step 802: Receiving a Request for Presenting Recommended Content to the User

The method begins at step 802 with the server 112 receiving the request 150 for presenting recommended content to the user 102.

In some embodiments of the present technology, the request 150 may be generated in response to the user 102 providing an explicit indication of a user desire to receive recommended content such as by clicking a button from the recommendation application 106. Therefore, the request 150 for a given set of recommendation items can be thought of as “an explicit request” in a sense of the user 102 expressly providing a request for the given set of recommendation items.

In other embodiments, the request 150 can be generated in response to the user 102 providing an implicit indication of the user desire to receive recommended content. In some embodiments of the present technology, the request 150 can be generated in response to the user 102 starting the recommendation application 106.

In yet further embodiments of the present technology, the request 150 can be generated even without the user 102 providing either explicit or implicit indication of the user desire to receive recommended content. For example, in those embodiments of the present technology where the recommendation application 106 is implemented as the browser, as previously mentioned, the request 150 can be generated in response to the user 102 opening the browser application and can be generated, for example, without the user 102 executing any additional actions other than activating the browser application. As another example, the request 150 can be generated in response to the user 102 opening a new tab of the already-opened browser application and can be generated, for example, without the user 102 executing any additional actions other than activating the new browser tab. In other words, the request 150 can be generated even without the user 102 knowing that the user 102 may be interested in obtaining the given set of recommendation items.

As another example, the request 150 may be generated in response to the user 102 selecting a particular element of the browser application and can be generated, for example, without the user 102 executing any additional actions other than selecting/activating the particular element of the browser application.

### Step 804: Receiving an Indication of Previous User Interactions of the User

The method 800 continues to step 804 with the server 112 receiving the indication 350 (see FIG. 3) of previous user interactions of the user 102 with the recommendation service.

For example, upon receiving the request 150, the server 112 may identify the user 102 based on the request 150 and may retrieve the indication 350 of the previous user interactions associated with the user 102 from the user interaction database 126.

As previously mentioned, the user interaction database 126 stores information related to user events/interactions associated with previous users of the system 100 (in this case, including the user 102). Naturally, the user events can be stored in an encrypted form. Examples of the user events include but are not limited to:
a given user of the recommendation system “scrolled over” a given item;
a given user of the recommendation system “liked” the given item;
a given user of the recommendation system shared the given item;
a given user of the recommendation system has clicked on (or otherwise selected) the given item; and
a given user of the recommendation system has purchased/ordered/downloaded the given item.

It should be expressly understood that the user events may take many forms and are not specifically limited. As such, above presented lists of non-limiting examples of the way that the user events and the item features may be implemented are just examples thereof. As such, it should be expressly understood that many other alternative implementations of the user events and the item features may be contemplated in different implementations of the present technology.

### Step 806: Generating a Ranked List of Recommendable Content Items

The method 800 continues to step 806 with the server 112 generating the ranked list of recommendable content items 400 (see FIG. 4). To that end, the server 112 may be configured to employ the first MLA 116 which is implemented by the server 112.

Prior to generating the ranked list of recommendable content items 400, the server 112 can receive the indication of content (or the content itself) from the plurality of web resources 130. To that end, the server 112 may receive a respective data packet from each one of the plurality of web resources 130.

For example, the server 112 may receive over the communication network 110 (i) the first data packet 162 from the first web resource 132, (ii) the second data packet 164 from the second web resource 134 and (i) the third data packet 166 from the first web resource 136. It should be noted that in alternative embodiments of the present technology, the first data packet 162, the second data packet 164, and the third data packet 166 are received in an offline mode (i.e. before receiving the request 150), such as once a day, once every hour or the like.

In some embodiments, a given web resource within the plurality of web resources 130 is a given web page accessible at its dedicated Universal Resource Locator (URL). Therefore, it can be said that a given web resource (such as one of: the first web resource 132, the second web resource 134, and the third web resource 136) may comprise content originating from a given web page. As such, each web resource may comprise a respective web page.

In other embodiments, a given web resource within the plurality of web resources 130 is a given plurality of web pages that are hosted by a common web domain. Therefore, it can be said that a given web resource (a first web resource 132, a second web resource 134 and a third web resource 136) may comprise the given plurality of web pages hosted by the common web domain. As such, each web resource may comprise web pages hosted by a common domain.

It is contemplated that each one of the plurality of web resources 130 may host a respective plurality of content items. Therefore, it can be said that content of a given web resource comprises content of given content items that are associated with the given web resource. Also, this means that content of a given content item originates from a respective web resource.

It should be noted that, in some cases, at least some of the plurality of web resources 130 may provide undesirable content. For example, at least one of the plurality of web resources 130 may provide a particular type of content, known as “click-bate” content, where a web content provider of the at least one of the plurality of web resources 130, in an attempt to draw user's clicks on their content, gives the content provocative or scandalous titles in order to capture user attention and, therefore, entice users to interact with this content. However, the operator of the recommendation service may have determined that “click-bate” content is undesirable for provision as recommended content to users of the recommendation system since, although this content will most likely be viewed/interacted with by a large number of users due to attractive titles, “click-bate” content may not be particularly relevant to these users.

Prior to generating the ranked list of recommendable content items 400, irrespective of whether each web resource comprises the given web page or the given plurality of web pages hosted by the given common domain, the server 112 may parse the web resource content in each data packet in order to identify given content items hosted by the plurality of web resources 130 and extract content associated with each one of the given content items.

The server 112 may be configured to parse each one of the first, second and third web resource content 202, 204 and 206 (see FIG. 2) received via the first, second and third data packets 162, 164 and 166, respectively, for identifying respective content items and extracting content associated with each one of the respective content items.

By parsing each web resource content, the server 112 may identify content items associated with and originating from each respective first web resource.

By parsing the first web resource content 202, the server 112 can extract the first content 212 which is representative of content of the content item I1, the second content 222 which is representative of content of the content item I2 and the third content 232 which is representative of content of the content item I3.

By parsing the second web resource content 204, the server 112 can extract the fourth content 214 which is representative of content of the content item I4, the fifth content 224 which is representative of content of the content item I5 and the sixth content 234 which is representative of content of the content item I6.

By parsing the third web resource content 206, the server 112 can extract the seventh content 216 which is representative of content of the content item I7, the eighth content 226 which is representative of content of the content item I8 and the ninth content 236 which is representative of content of the content item I9.

Therefore, it can be said that each one of the content items I1, I2, I3, I4, I5, I6, I7, I8 and I9 is associated with a respective web resource (e.g., the content items I1, I2 and I3 are associated with the first web resource 132, the content items I4, I5 and I6 are associated with the second web resource 134 and the content items I7, I8 and I9 are associated with the third web resource 136).

Prior to generating the ranked list of recommendable content items 400, the server 112 analyzes each one of the content 212, 222, 232, 214, 224, 234, 216, 226 and 236 in order to determine item features associated with each one of the content items I1, I2, I3, I4, I5, I6, I7, I8 and I9, respectively. The server 112 may analyze the content of a given content item in order to determine item-inherent characteristics that are based on content of the respective content item.

In some cases, at least some of the content items I1, I2, I3, I4, I5, I6, I7, I8 and I9 may have been previously recommended by the recommendation service to its previous users and with which at least one previous user has interacted. In other words, the at least some of the content items may have been previously stored in the recommendable content item database 124 for which respectively associated item features have been previously stored in the item feature database 122. In these cases, prior to generating the ranked list of recommendable content items 400, the server 112 may retrieve from the item feature database 122 other item features, in addition to the item-inherent characteristics, associated with each one of the at least some content items.

Therefore, it can be said that each one of the content items I1, I2, I3, I4, I5, I6, I7, I8 and I9 is associated with respective item features. This means that:
the content item I1 is associated with the feature information 301 representative of item features of the content item I1;
the content item I2 is associated with the feature information 302 representative of item features of the content item I2;
the content item I3 is associated with the feature information 303 representative of item features of the content item I3;
the content item I4 is associated with the feature information 304 representative of item features of the content item I4;
the content item I5 is associated with the feature information 305 representative of item features of the content item I5;
the content item I6 is associated with the feature information 306 representative of item features of the content item I6;
the content item I7 is associated with the feature information 307 representative of item features of the content item I7;
the content item I8 is associated with the feature information 308 representative of item features of the content item I8; and
the content item I9 is associated with the feature information 309 representative of item features of the content item I9.

Based on the item features of each of the content items I1, I2, I3, I4, I5, I6, I7, I8 and I9 and the indication 350 of previous user interactions associated with the user 102, the server 112 is configured to generate a respective user-specific ranking score for each one of the content items I1, I2, I3, I4, I5, I6, I7, I8 and I9.

In other to generate the ranked list of recommendable content items 400, the server 112 generates the plurality of user-specific ranking scores 390 depicted in FIG. 3. The server 112 may employ the first MLA 116 for generating a respective user-specific ranking score for each one of the content items I1, I2, I3, I4, I5, I6, I7, I8 and I9. The first MLA 116 is referred herein as the “user-specific-ranking” MLA since the first MLA 116 generates user-specific ranking scores that are indicative of estimated relevance of respective content items to a specific user (in this case, they are indicative of the respective estimated relevance of the content items I1, I2, I3, I4, I5, I6, I7, I8 and I9 to the user 102).

The first MLA 116 has been trained to generate user-specific ranking scores for content items based on respective item features and the indication 350 of previous user interactions of the user 102 with the recommendation service.

With reference to FIG. 3, there is depicted the indication 350 of previous user interactions of the user 102 with the recommendation service as well as each item feature information representative of the respective item features associated with a respective one of the content items I1, I2, I3, I4, I5, I6, I7, I8 and I9. The first MLA 116 (user-specific-ranking MLA) is inputted with the indication 350 of previous user interactions and the feature information associated with each one of the content items I1, I2, I3, I4, I5, I6, I7, I8 and I9 and outputs a respective user-specific ranking score for each one of the content items I1, I2, I3, I4, I5, I6, I7, I8 and I9.

It is contemplated that the server 112 may store in the main database 120 the plurality of user-specific ranking scores 390 with associations to the respectively associated content items.

When the plurality of user-specific ranking scores 390 is generated, the first MLA 116 implemented by the server 112 generates the ranked list of recommendable content items 400 depicted in FIG. 4 which, in this case, comprises the content items I1, I2, I3, I4, I5, I6, I7, I8 and I9 that are ranked based on their respectively associated user-specific ranking scores of the plurality of user-specific ranking scores 390. The server 112 may store the ranked list of recommendable content items 400 in the main database 120 for further processing thereof.

A given content item with the highest user-specific ranking score of the plurality of user-specific ranking scores 390 will be associated with the highest rank in the ranked list of recommendable content items 400 while another given content item associated with the lowest user-specific ranking score of the plurality of user-specific ranking scores 390 will be associated with the lowest rank in the ranked list of recommendable content items 400.

It should be noted that the content items I1, I2, I3, I4, I5, I6, I7, I8 and I9 are ranked in the ranked list of recommendable content items 400 based on their estimated relevance to the user 102.

As previously mentioned, the content item I2 is associated with the highest estimated relevance to the user 102, since the second user-specific ranking score 322 associated with the content item I2 is the highest user-specific ranking score of the plurality of user-specific ranking scores 390.

As previously mentioned, the content item I8 is associated with the lowest estimated relevance to the user 102, since the eighth user-specific ranking score 326 associated with the content item I8 is the lowest user-specific ranking score of the plurality of user-specific ranking scores 390.

It should also be noted that, in this case, the content item I4 is ranked 2^{nd} in the ranked list of recommendable content items 400 and the content item I7 is ranked 5^{th} in the ranked list of recommendable content items 400.

However, as previously mentioned, at least some content items amongst the content items I1, I2, I3, I4, I5, I6, I7, I8 and I9 may be associated with potentially undesirable content for users of the recommendation service. Generally speaking, even though a given content item is estimated to be highly relevant for a given user, this given content item may still be associated with potentially undesirable content for recommendation to users of the recommendation service based on the pre-determined content policies. For example, a given “click-bate” content item may be estimated to be highly relevant for a given user since it may be associated with a large amount of user interactions (e.g., clicks). Thus, the given “click-bate” content item may have a large relevancy score which will result in the “click-bate” content item being ranked higher based on relevancy than it should be since, in this case where the content is “click-bate” content, the amount of user interactions is a flawed indicator of its relevancy to the given user.

### Step 808: Generating a Demoting Score for Each Content Item

The method 800 continues to step 808 with the server 112 generating a respective demoting score for each content item in the ranked list of recommendable content items 400.

To that end, the server 112 employs the second MLA 118. The second MLA 118 during its in-use phase is configured to generate demoting scores for content items. In order to generate demoting scores for content items, the second MLA 118 is trained during its training phase.

Generally speaking, the second MLA 118 is trained to receive a given content item and to output, for the inputted given content item, a demoting score indicative of a degree of undesirability of the inputted content. Broadly speaking, the MLA 118 is configured to output the demoting score based on: (i) content of a given content item; (ii) content of a plurality/all content items of the web resource; and (iii) combination of (i) and (ii).

As previously mentioned, in order to identify undesirable content, the operator may have determined content policies which are indicative of various types of undesirable content such “click-bate” content, violent content, sexually-explicit content, gore content, obscene content, and the like. Thus, the training of the second MLA 118 may be at least partially based on the pre-determined content policy(ies) having been pre-determined by the operator of the recommendation service.

In some embodiments, the second MLA 118 may be trained based on “undesired content indicators” which are based in turn on the pre-determined content policies. As previously mentioned, the undesired content indicators may be representative of heuristic rules which, when confirmed following the analysis of a given content item, are indicative of the given content item being of a type that is included in the pre-determined content policies.

In other embodiments, the second MLA 118 may be trained based on pre-determined training data which has been generated based on the pre-determined content policies. As previously mentioned, the training data may be generated by the server 112 following a rating of the plurality of training content (e.g., content of a plurality of training content items) by the plurality of assessors. The server 112 may generate a plurality of “training content-assessor rating” pairs which are used as the training data for training the second MLA 118.

It is contemplated that, the plurality of training content (e.g., content of the plurality of training content items) may or may not originate from the plurality of web resource 130. The plurality of training content may originate from a plurality of network sources which may or may not include at least some of the plurality of web resource 130.

During its training phase, the second MLA 118 learns, in a sense, relationships and/or data patterns between the plurality training content (e.g., content of the plurality of training content items) and respectively associated assessor ratings, which are based on the pre-determined content policies, in order to (i) classify given content inputted therein during the in-use phase and (ii) generate a given demoting score for the given content based on the classification.

The second MLA 118 may be trained to associate a given content inputted therein with at least one content class amongst a plurality of content classes. In some embodiments, the plurality of content classes may comprise (i) at least one undesirable-content class and (ii) at least one neutral-content class.

The at least one undesirable-content class may be associated with a given type of undesirable content included in the pre-determined content policies, while content not associated with any type of undesirable content may be associated with the at least one neutral-content class.

In other embodiments, the at least one undesirable-content class may comprise a set of undesirable-content classes where each undesirable-content class in the set of undesirable-content classes is associated with a respective type of undesirable content included in the pre-determined content policies. For example, a first undesirable-content class in the set of undesirable-content classes may be associated with “click-bate” content while a second undesirable-content class in the set of undesirable-content classes may be associated with sexually-explicit content.

When a given content is classified by the second MLA 118 into one of the plurality of content classes, the second MLA 118 may generate a given demoting score for the given content based on the respective content class of the plurality of content classes to which the given content is classified. The second MLA 118 is referred herein as a “user-independent-classifying” MLA since, unlike the first MLA 116, the second MLA 118 was not trained on and does not use information associated with users of the recommendation service for generating the demoting scores. The second MLA 118 generates demoting scores in a user-independent manner and on a content-specific basis, and not on a user-specific basis.

It can be said that the second MLA 118 is trained to generate demoting scores for content items based on content originating from the respective web resources and where each demoting score is indicative of the degree of undesirability of the content originating from the respective web resource. It is contemplated that each demoting score may indicative of the degree of undesirability of at least the content of a respective content item.

After completion of the training phase of the second MLA 118, during the in-use phase of the second MLA 118, the server 112 inputs content of each of the content items I1, I2, I3, I4, I5, I6, I7, I8 and I9 into the second MLA 118 which outputs a respective demoting score for each one of the content items I1, I2, I3, I4, I5, I6, I7, I8 and I9.

It is contemplated that the manner in which training content (e.g., content of the plurality of training content items), which is inputted and used during the training-phase of the second MLA 118, is implemented may be similar to the manner in which in-use content (e.g., content of each one of the content items I1, I2, I3, I4, I5, I6, I7, I8 and I9), which is inputted and used during the in-use phase of the second MLA 118, is implemented.

It is contemplated that the second MLA 118 may generate demoting scores for content items based on different combinations of content originating from the respective web resource—such as individual content items, content of all content items, or content of a selected subset of content items (such as those displayed on a landing page).

In one embodiment, the second MLA 118 may be configured to generate a given demoting score for a given content item based on the content of the given content item (this content originates from the respective web resource hosting the given content item). In this embodiment, the second MLA 118 may generate demoting scores on an item-by-item basis such that each demoting score is based on the content of each respective content item only.

Therefore, it can be said that, in one embodiment, the content originating from the respective web resource used to generate a respective demoting score may be the content of the respective content item hosted by the respective web resource.

In another embodiment, the second MLA 118 may be configured to generate a given demoting score for a given content item based on an aggregate of content of all content items originating from a given web resource. This means that the second MLA 118 may generate an identical demoting score for each given content item originating from the same web resource since each one of their demoting scores will be based on a same aggregate of content originating from the same web resource. In this embodiment, it can be said that the second MLA 118 may be configured to generate demoting scores based on a web resource-by-web resource basis such that each demoting score is based on the aggregate of content of all content items originating from a same web resource.

Therefore, it can be said that, in another embodiment, the content originating from the respective web resource used to generate a respective demoting score may be the aggregate of the content of all content items hosted by the respective web resource.

In other embodiments, the second MLA 118 may be configured to generate demoting scores on a combination of an item-by-item basis and on a web resource-by-web resource basis. The second MLA 118 may generate (i) a given item-by-item demoting score for a given content item based on its respectively associated content and (ii) a given web resource-by-web resource demoting score for this given content item based on the aggregate of content of all content items originating from a respective web resource from which the given content item originates. It is therefore contemplated that the second MLA 118 may generate a given demoting score for a given content item as a weighted sum of (i) the item-by-item demoting score of the given content item score and (ii) the web resource-by-web resource demoting score of the given content item.

Therefore, it can be said that the second MLA 118 may be configured to generate demoting scores on a hybrid item-web resource basis such that a given demoting score is based on (i) the content of the respective content item and (ii) the aggregate of content of all content items originating from a same web resource as the respective content item.

It is contemplated that the weights applied to a given item-by-item demoting score and to a given web resource-by-web resource demoting score of each respective content item in each respective weighted sum may have been pre-determined by the operator of the recommendation service.

Therefore, it can be said that, in other embodiments, the content originating from the respective web resource used to generate a respective demoting score may be (i) the aggregate of the content of all content items hosted by the respective web resource weighted with a first weight and (ii) content of the respective content item weighted with a second weight.

Irrespective of the basis on which a given demoting score is generated for a given content item by the second MLA 118, the given demoting score associated with the respective content item is indicative of the degree of undesirability of content originating from the respective web resource.

The server 112 may store in the main database 120 the plurality of demoting scores 590 (see FIG. 5) with associations to the respectively associated content items.

In some embodiments, the second MLA 118 may be configured to classify content originating from the first, second and third web resources 132, 134 and 136 prior to the receipt of the request 150. In other words, the second MLA 118 may “pre-classify” the content originating from respectively the first, second and third web resources 132, 134 and 136 into a respective one of at least one of the plurality of content classes (similarly to how it is described above, but prior to the receipt by the server 112 of the request 150 for presenting recommended content to the user 102). The second MLA 118 may also be configured to generate demoting scores on the web resource-by-web resource basis prior to the receipt of the request 150. In other words, all content originating from a given host may be demoted by the same demoting score.

In other embodiments, the second MLA 118 may be configured to, on a periodic basis, (i) classify content originating from the first, second and third web resources 132, 134 and 136 and (ii) generate demoting scores on the web resource-by-web resource basis. For example, at a first moment in time, the second MLA 118 may be configured to (i) classify, for the first moment in time, content originating from the first, second and third web resources 132, 134 and 136 and (ii) generate demoting scores, for the first moment in time, on the web resource-by-web resource basis. Also, at a second moment in time, the second MLA 118 may be configured to (i) classify, for the second moment in time, content originating from the first, second and third web resources 132, 134 and 136 and (ii) generate demoting scores, for the second moment in time, on the web resource-by-web resource basis. As a result, the classification of the content originating from the first, second and third web resources 132, 134 and 136 at the first moment in time may be different from its classification at the second moment in time and, as such, demoting scores generated on the web resource-by-web resource basis for the first moment in time may be different from the demoting scores generated on the web resource-by-web resource basis at the second moment in time.

Therefore, it can be said that if the content originating from a given one of the first, second and third web resources 132, 134 and 136 is classified as undesirable content by the second MLA 118 at the second moment in time, even though the content originating from the given one of the first, second and third web resources 132, 134 and 136 was not classified as undesirable content by the second MLA 118 at the first moment in time, the demoting scores for the second moment in time may be higher than the demoting scores for the first moment in time. Similarly, it can be said that if the content originating from a given one of the first, second and third web resources 132, 134 and 136 is not classified as undesirable content by the second MLA 118 at the second moment in time, even though the content originating from the given one of the first, second and third web resources 132, 134 and 136 was classified as undesirable content by the second MLA 118 at the first moment in time, the demoting scores for the second moment in time may be lower than the demoting scores for the first moment in time.

It should be noted that the classification of the content originating from a given one of the first, second and third web resources 132, 134 and 136 at the first moment in time may be different from its classification at the second moment in time since the content originating from the given one of the first, second and third web resources 132, 134 and 136 at the first moment in time may be different from the content originating from the given one of the first, second and third web resources 132, 134 and 136 at the second moment in time.

### Step 810: Generating an Adjusted Ranking Score for Each Content Item

The method 800 continues to step 810 with the server 112 generating adjusted ranking scores for each respective content item in the ranked list of recommendable content items 400 based on the respective user-specific ranking score and the respective demoting score.

With reference to FIG. 6, the server 112 generates a respective adjusted ranking score for each one of the content items I1, I2, I3, I4, I5, I6, I7, I8 and I9. The server 112 generates the plurality of adjusted ranking scores 690 based on the plurality of user-specific ranking scores 390 and the plurality of demoting scores 590.

It is contemplated that each adjusted ranking score is generated at least partially in a user-specific manner and at least partially in a user-independent manner. In other words, each adjusted ranking score is generated at least partially based on previous user interactions of a specific user (the user-specific portion) and on content originating from the web resource of a respective content item (the user-independent portion).

It should be noted that, in some implementations, demoting scores and user-specific ranking scores may be of opposite signs. Put another way, a given adjusted ranking score may be inferior to the respective user-specific ranking score.

It should be noted that, in this case, (i) the fourth adjusted ranking score 614 of the content item I4 is inferior to the fourth user-specific ranking score 314 of the content item I4 and (ii) the seventh adjusted ranking score 616 of the content item I7 is inferior to the seventh user-specific ranking score 316 of the content item I7.

It is contemplated that content items ranked based on the respective user-specific ranking scores may not preserve their respective ranks when ranked based on the respective adjusted ranking scores. Therefore, ranks of at least some content items may be demoted if the content items are ranked based on the adjusted ranking scores in comparison to their ranks if the content items are ranked based on the user-specific ranking scores.

Therefore, it can be said that, in some embodiments of the present technology, content items ranked on a user-specific basis (user-specific manner) may not preserve their ranks when ranked on a combination of (i) a user-specific basis and (ii) a content-specific basis (user-independent manner).

The server 112 may store in the main database 120 the plurality of adjusted ranking scores 690 with associations to the respectively associated content items.

### Step 812: Generating a Modified Ranked List of Recommendable Content Items Based on the Content Items and the Adjusted Ranking Scores

The method 800 continues to step 812 with the server 112 generating the modified ranked list of recommendable content items 700 (see FIG. 7) to be presented to the user 102 based on the content items I1, I2, I3, I4, I5, I6, I7, I8 and I9 and the respectively associated adjusted ranking scores of the plurality of adjusted ranking score 690.

The content items in the modified ranked list of recommendable content items 700 are ranked according to the respective adjusted ranking scores. This means that a given content item with the highest adjusted ranking score of the plurality of adjusted ranking scores 690 will be associated with the highest rank in the modified ranked list of recommendable content items 700 while another given content item associated with the lowest adjusted ranking score of the plurality of adjusted ranking scores 690 will be associated with the lowest rank in the modified ranked list of recommendable content items 700.

It should be noted that the content items in the modified ranked list of recommendable content items 700 are ranked amongst each other by taking into account simultaneously (i) the estimated relevance of each respective content item and (ii) the degree of undesirability of content originating from the web resource of each respective content item.

In some embodiments of the present technology, content items ranked based on the estimated relevance of each respective content item may not preserve their ranks when ranked on a combination of (i) the estimated relevance of each respective content item and (ii) the degree of undesirability of content originating from the web resource of each respective content item.

The server 112 may store in the main database 120 the content items I1, I2, I3, I4, I5, I6, I7, I8 and I9 in association with their respective ranks in the modified ranked list of recommendable content items 700.

With reference to FIGS. 4 and 7, it should be noted that the ranks of at least some content items in the modified ranked list of recommendable content items 700 are different from their respective ranks in the ranked list of recommendable content items 400.

As previously mentioned, the content item I4 is ranked 2^{nd} in the ranked list of recommendable content items 400 while being ranked 5^{th} in the modified ranked list of recommendable content items 700. In another example, the content item I7 is ranked 5^{th} in the ranked list of recommendable content items 400 while being ranked 9^{th} in the modified ranked list of recommendable content items 700.

Therefore, it is contemplated that the adjusted rank of a given content item (the rank of the content item in the modified ranked list of recommendable content items 700) can be inferior to its given rank in the ranked list of recommendable content items 400.

This rank demotion, from their given ranks in the ranked list of recommendable content items 400 to their adjusted ranks in the modified ranked list of recommendable content items 700, of the content items I4 and I7 is indicative of the content items I4 and I7 being likely associated with undesirable content.

### Step 814: Triggering a Presentation of a Ranked Recommended List of Content Items as the Ranked Recommended Content

The method 800 ends at step 814 with the server 112 triggering the presentation of a given ranked recommended list of content items to the user 102 on the electronic device 104 as the ranked recommended content. The ranked recommended list of content items comprises at least some content items from the modified ranked list of recommendable content items 700.

In some embodiments, the modified ranked list of recommendable items 700 may be used as the given ranked recommended list of content items. This means that the server 112 may be configured to trigger the presentation of the modified ranked list of recommendable items 700 to the user 102 as the ranked recommended content. As such, the server 112 may trigger the presentation of the content items I4 and I7 to the user according to their respective adjusted ranks (5^{th} and 9^{th} ranks respectively) in the modified ranked list of recommendable content items 700.

The server 112 can generate a data packet, such as the response 153, which in this case comprises information indicative of the modified ranked list of recommendable content items 700 and instructions for triggering the presentation thereof by the electronic device 104. The server 112 may transmit the response 153 to the electronic device 104 via the communication network 110 for triggering the presentation of the modified ranked list of recommendable content items 700 to the user 102.

In other embodiments, prior to generating and transmitting the response 153, the server 112 may be configured to furnish the modified ranked list of recommendable content items 700 to the auxiliary recommendation algorithm 119 (see FIG. 1) for selecting at least some content items from the modified ranked list of recommendable content items 700 to be included in the given ranked recommended list of content items.

The auxiliary recommendation algorithm 119 may select content items, from the modified ranked list of recommendable content items 700 to be included in the given ranked recommended list of content items, that are associated with respective adjusted ranking scores that are superior to the pre-determined adjusted ranking score threshold. As previously mentioned, the pre-determined adjusted ranking score threshold may have been determined by the operator of the recommendation service.

The auxiliary recommendation algorithm 119 may determine (i) that the content items I2, I1, I3, I6, I4 and I5 are associated with respective adjusted ranking scores that are superior to the pre-determined adjusted ranking score threshold and/or (ii) that the content items I9, I8 and I7 are associated with respective adjusted ranking scores that are inferior to the pre-determined adjusted ranking score threshold. As such, the auxiliary recommendation algorithm 119 may select the I2, I1, I3, I6, I4 and I5 from the modified ranked list of recommendable content items 700 and may include them into the given ranked list of recommended content items according to their respective ranked order in the modified ranked list of recommendable content items 700.

Therefore, it is contemplated that the auxiliary recommendation algorithm 119 implemented by the server 112 may limit the modified ranked list of recommendable items 700 to a pre-determined number of top ranked recommendable content items according to the respective adjusted ranking scores. In this case, a limited modified ranked list of recommendable content items 700 may be used as the given ranked list of recommended content items.

It is contemplated that the method 800 may further comprise a step of limiting the modified ranked list of recommendable content items 700 to a pre-determined number of top ranked recommendable content items according to the respective adjusted ranking scores. For example, the server 112 may limit the given modified ranked list of recommendable content items to the top 2, 3, 4, 5, 10, 15 or the like, content items.

The server 112 can generate the response 153 which in this case comprises information indicative of the ranked recommended list of content items comprising the content items I2, I1, I3, I6, I4 and I5 (ranked according to their respective ranks in modified ranked list of recommendable content items 700) and instructions for triggering the presentation thereof by the electronic device 104. The server 112 may transmit the response 153 to the electronic device 104 via the communication network 110 for triggering the presentation of the ranked recommended list of content items to the user 102.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of presenting a recommended content item to a user on an electronic device, the recommended content item being associated with potentially undesirable content, method executable on a server hosting a recommendation service, the method comprising:
receiving, by the server, a request for presenting recommended content to the user;
receiving, by the server, an indication of previous user interactions of the user with the recommendation service;
generating, by a user-specific-ranking MLA implemented by the server, a ranked list of recommendable content items,
each content item in the ranked list of recommendable content items being associated with respective item features and a respective web resource, the item features of each content item being based on content of the respective content item, the content of each content item originating from the respective web resource,
the user-specific-ranking MLA having been trained to generate user-specific ranking scores for content items based on respective item features and the indication of previous user interactions of the user with the recommendation service,
each content item in the ranked list of recommendable content items being associated with a respective user-specific ranking score being indicative of an estimated relevance of the respective content item to the user,
a given content item in the ranked list of recommendable content items being associated with a given rank in the ranked list of recommendable content items;
generating, by a user-independent-classifying MLA implemented by the server, a demoting score for each content item in the ranked list of recommendable content items,
the user-independent-classifying MLA having been trained to classify content originating from the respective web resource into one of a plurality of content classes and to generate demoting scores for content items based on the respective one of the plurality of content classes of content originating from the respective web resources, each demoting score being indicative of a degree of undesirability of the content originating from the respective web resource;
generating, by the server, an adjusted ranking score for each content item in the ranked list of recommendable content items based on the respective user-specific ranking score and the respective demoting score, the adjusted ranking score of the given content item being inferior to the user-specific ranking score of the given item;
generating, by the server, a modified ranked list of recommendable content items to be presented to the user based on the content items and the respectively associated adjusted ranking scores, the content items in the modified ranked list of recommendable content items being ranked according to the respective adjusted ranking scores, the given content item being associated with an adjusted rank in the modified ranked list of recommendable content items, the adjusted rank being inferior to the given rank; and
triggering, by the server, a presentation of a ranked recommended list of content items to the user on the electronic device as the ranked recommended content, the ranked recommended list of content items comprising at least some content items from the modified ranked list of recommendable content items, the given content item being presented to the user at the adjusted rank in the modified ranked list of recommendable content items.

2. The method of claim 1, wherein the plurality of content classes comprises at least one undesirable-content class and at least one neutral-content class.

3. The method of claim 2, wherein the at least one undesirable-content class comprises a set of undesirable-content classes, each one of the set of undesirable-content classes being associated with a respective type of undesirable content included in pre-determined content policies.

4. The method of claim 1, wherein the content originating from the respective web resources is an aggregate of the content of all content items hosted by the respective web resource.

5. The method of claim 1, wherein the content originating from the respective web resources is the content of the respective content item.

6. The method of claim 1, wherein the content originating from the respective web resources is:
an aggregate of content of all content items hosted by the respective web resource weighted with a first weight; and
content of the respective content item weighted with a second weight.

7. The method of claim 1, wherein each web resource comprises web pages hosted by a common domain.

8. The method of claim 1, wherein each web resource comprises a respective web page.

9. The method of claim 1, wherein the method further comprises limiting, by the server, the modified ranked list of recommendable items to a pre-determined number of top ranked recommendable content items according to the respective adjusted ranking scores.

10. The method of claim 1, wherein:
the user-independent-classifying MLA has been trained to classify content originating from the respective web resource into one of a plurality of content classes and to generate demoting scores for content items based on the respective one of the plurality of content classes of content originating from the respective web resources and a pre-determined content policy.

11. The method of claim 8, wherein the pre-determined content policy has been pre-determined by an operator of the user-independent-classifying MLA.

12. The method of claim 11, wherein the pre-determined content policy is indicative of a type of undesirable content.

13. The method of claim 1, wherein the content originating from a given web resource is classified, by the user-independent-classifying MLA, on a periodic basis.

14. The method of claim 1, wherein the content originating from a given web resource is classified, by the user-independent-classifying MLA, into (i) a first one of the plurality of content classes at a first moment in time and (ii) a second one of the plurality of content classes at a second moment in time.

15. The method of claim 14, wherein at least one of the first moment in time and the second moment in time is prior to the receiving, by the server, the request for presenting the recommended content to the user.

16. A server for presenting a recommended content item to a user on an electronic device, the recommended content item being associated with potentially undesirable content, the server hosting a recommendation service, the server being configured to:
receive a request for presenting recommended content to the user;
receive an indication of previous user interactions of the user with the recommendation service;
generate, by a user-specific-ranking MLA implemented by the server, a ranked list of recommendable content items,
each content item in the ranked list of recommendable content items being associated with respective item features and a respective web resource, the item features of each content item being based on content of the respective content item, the content of each content item originating from the respective web resource,
the user-specific-ranking MLA having been trained to generate user-specific ranking scores for content items based on respective item features and the indication of previous user interactions of the user with the recommendation service,
each content item in the ranked list of recommendable content items being associated with a respective user-specific ranking score being indicative of an estimated relevance of the respective content item to the user,
a given content item in the ranked list of recommendable content items being associated with a given rank in the ranked list of recommendable content items;
generate, by a user-independent-classifying MLA implemented by the server, a demoting score for each content item in the ranked list of recommendable content items,
the user-independent-classifying MLA having been trained to classify content originating from the respective web resource into one of a plurality of content classes and to generate demoting scores for content items based on the respective one of the plurality of content classes of content originating from the respective web resources, each demoting score being indicative of a degree of undesirability of the content originating from the respective web resource;
generate an adjusted ranking score for each content item in the ranked list of recommendable content items based on the respective user-specific ranking score and the respective demoting score, the adjusted ranking score of the given content item being inferior to the user-specific ranking score of the given item;
generate a modified ranked list of recommendable content items to be presented to the user based on the content items and the respectively associated adjusted ranking scores, the content items in the modified ranked list of recommendable content items being ranked according to the respective adjusted ranking scores, the given content item being associated with an adjusted rank in the modified ranked list of recommendable content items, the adjusted rank being inferior to the given rank; and
trigger a presentation of a ranked recommended list of content items to the user on the electronic device as the ranked recommended content, the ranked recommended list of content items comprising at least some content items from the modified ranked list of recommendable content items, the given content item being presented to the user at the adjusted rank in the modified ranked list of recommendable content items.

17. The server of claim 16, wherein the plurality of content classes comprises at least one undesirable-content class and at least one neutral-content class.

18. The server of claim 17, wherein the at least one undesirable-content class comprises a set of undesirable-content classes, each one of the set of undesirable-content classes being associated with a respective type of undesirable content included in pre-determined content policies.

19. The server of claim 16, wherein the content originating from the respective web resources is an aggregate of the content of all content items hosted by the respective web resource.

20. The server of claim 16, wherein the content originating from the respective web resources is the content of the respective content item.
